(19) United States
(12) Patent Application Publication
(10) Pub. No.: US 2010/0318228 A1
(43) Pub. Date: Dec. 16, 2010

(54) Method and Apparatus for Predicting Properties of Granulated Materials and Dosage Forms made Therefrom

(75) Inventor: Donald James Clancy, King of Prussia, PA (US)

Correspondence Address: GlaxoSmithKline;GLOBAL PATENTS -US, UW2220, P. O. BOX 1539, KING OF PRUSSIA, PA, 19406-0939, US

(73) Assignee: GlaxoSmithKline LLC

(21) Appl. No.: 12/865,156

(22) PCT Filed: Jan. 30, 2009
(86) PCT No.: PCT/US09/32589

§ 371 Date: Jul. 29, 2010

Related U.S. Application Data
(60) Provisional application No. 61/006,844, filed on Feb. 1, 2008.

(51) Int. Cl. G05B 13/04; G06G 7/57; G05D 9/12; G05D 7/06

(52) U.S. Cl. 700/281; 703/9; 700/282

(57) ABSTRACT

A method and system for estimating, predicting, and/or controlling a granulation process are disclosed. The method may account for changes in input water amount, how material responds to the water amount, batch size, power input, and particle size, specific surface area, or dynamic cohesion of the materials being granulated. The method may also account for an impeller load, relative impeller efficiency, and water content. The method may measure point where material being granulated is responding to the water addition. The method may predict tap density of the granules exiting a mill downstream of granulation, after a drying process. The method may predict tablet dissolution. The system may include a controller having a computer executable program embodied in a computer readable medium and configured to perform one or more steps of the method. The system may also control various processing equipment in response to estimates and/or predictions.

### TECHNICAL FIELD

Jet Mills are increasingly being used to finely grind powders in both the Electronics and Pharmaceutical industries. Electronic companies mill to pack more electrical functionality into a smaller space, and Pharmaceutical companies mill because the increasingly complex molecules being produced are increasingly less soluble. Unfortunately, the resulting “micronized” powders are difficult to work with because they have poor flow and low density. To process the powders, both industries use wet granulation processes to agglomerate the material into larger granules as described in Dilip M. Parikh; Handbook of Pharmaceutical Granulation Technology, Second Edition, Published 1997 Marcel Dekker which is incorporated herein by reference. (see Dilip M. Parikh; Handbook of Pharmaceutical Granulation Technology, Second Edition, Published 1997, Marcel Dekker.) Both industries typically need to control the resulting granule size and granule density/porosity, as these parameters are often the primary quality attributes that affect the functionality of the finished product, e.g., dosage forms (pharmaceuticals) and capacitors (electronics) as described in Emori H, et al. Prospective validation of high-shear wet granulation process by wet granule sieving method. II. Utility of wet granule sieving method. See Emori H, et al. Prospective validation of high-shear wet granulation process by wet granule sieving method. II. Utility of wet granule sieving method. Drug Dev Ind Pharm 23(2):203-215, 1997.

For both the pharmaceutical and electronics industries, the density or porosity of the resulting granulated material is often an important parameter, and can be independent from the granulated particle size distribution. Downstream milling can often correct the granulated product for size variation, but little can be done to correct a granulation that resulted in too high or too low of a granule density, i.e., an over-granulated or under-granulated material. While some analysis may indicate that densification of the material and the associated porosity loss is important, there is not at present a process tool configured to predict densification or provide instrumentation concepts to follow it in real time during the granulation process. The present invention is directed to providing these industries with such a tool.

For pharmaceuticals, powder density affects how materials compress into tablets at a given hardness. For electronics, the powder density affects the fired capacitor chip “crush value” at a given compressed density. Porosity affects how water or other fluids can wet into the granules affecting dissolution of, for example, dosage forms (pharmaceuticals) or deposition of a counter-electrode and resulting capacitance in valve metal capacitors (electronics). Density and binder content affect the strength of the granule, which along with particle size distribution, affects the granule friability and the extra-granular porosity within a compressed body. Both industries may require careful control of granulated density to ensure a consistent product. For example, in pharmaceutical industries, a granulated material may be subsequently formed into a dosage form, e.g., a tablet, and improperly granulated materials may adversely affect the dissolution time of the dosage form by, e.g., resulting in a dissolution time that is less than or greater than a predetermined or desired time range.

Viscosity is generally considered a bulk measurement of significant importance for engineering models that describe bulk processing of liquids. Process equipment typically reacts to the bulk properties of the material instead of reacting to the microscopic properties of the material. Because of viscosity, engineering models describing liquid behavior in processing systems do not have to examine all the molecular properties, many of which are impossible to precisely measure. Viscosity is typically used as a single bulk measurement to describe the combined molecular interactions that result in resistance to displacement due to inter-molecular friction. At present, no direct analogy of viscosity in liquid systems has been developed for powder systems in a dynamic mixed environment, even though powders exhibit a resistance to displacement that is a function of the number of particle to particle interactions and the friction of each particle interaction. The result of the particle-to-particle surface interactions is typically referred to as “cohesion.”

“Useful” work must be done to increase the density of any compressible material, be it a gas or a compressible solid. For micronized powders, substantial densification occurs in the granulation process. The densification of the powder bed is responding in some manner to the useful work being done in granulation, which is a function of the cumulative torque multiplied by revelations per minute (RPM) of the impeller, i.e., cumulative impeller load, observed per unit powder mass. The resulting units of work done are (watt*sec)/gram or joules/gram. The present invention provides for algorithms installed in control equipment to more easily provide accurate control of granulation processes.

### DETAILED DESCRIPTION OF THE DRAWINGS

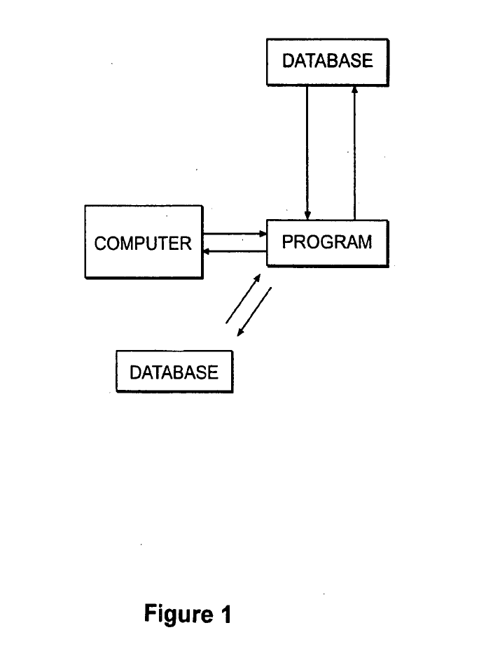

FIG. 1 describes a method of this invention as embodied in an apparatus that may include a computer, a program, and/or one or more databases.

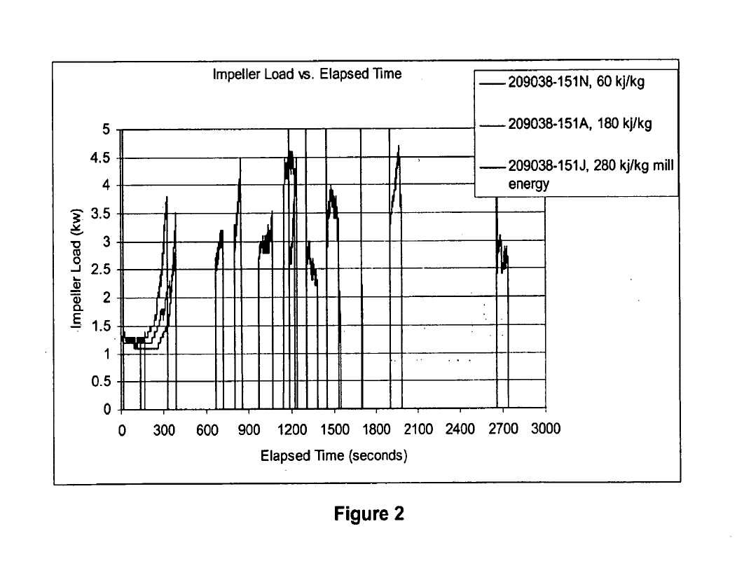

FIG. 2 describes a comparison between impeller load and elapsed granulation time (seconds) for three lots, a 60 kJ/kg, 180 kJ/kg, and a 280 kJ/kg lot.

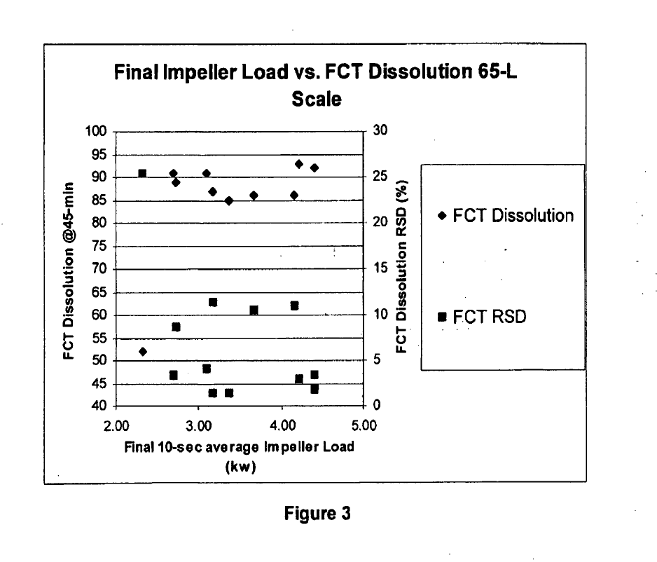

FIG. 3 describes a comparison between the final 10-second average impeller load and FCT dissolution p@ 45-min percentage and density of 12 samples at a 65 L scale.

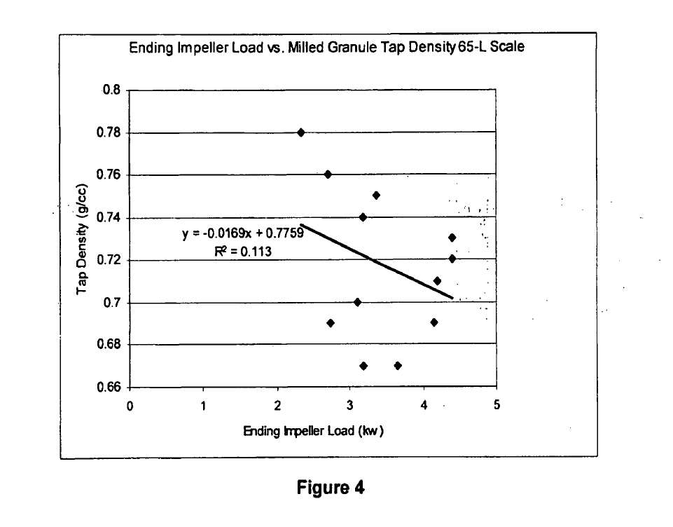

FIG. 4 describes a comparison between ending impeller load and milled granule tap density at a 65 liter (hereinafter “L”) scale.

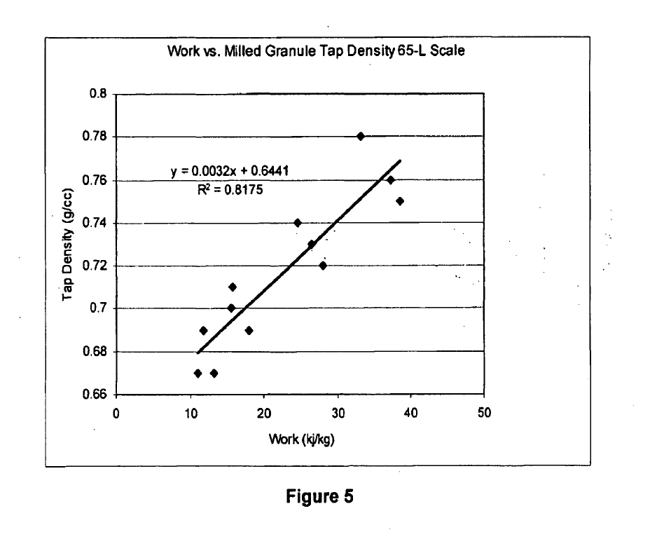

FIG. 5 describes a comparison between work and tap density.

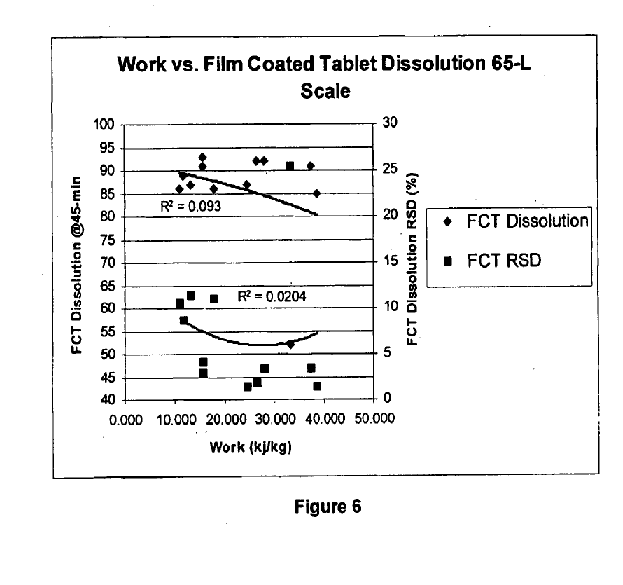

FIG. 6 describes a comparison between work, dissolution percentage and density for 12 samples.

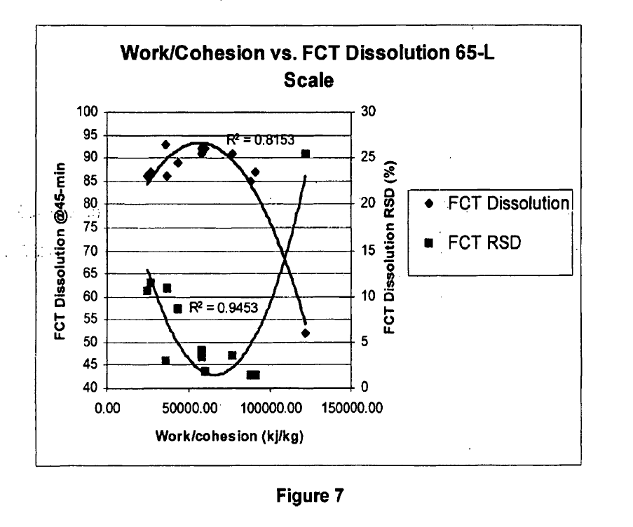

FIG. 7 describes a comparison between work/cohesion.

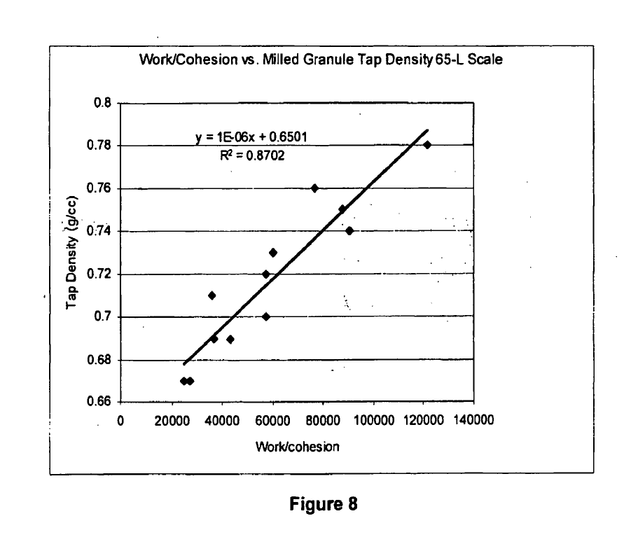

FIG. 8 describes a comparison between work/cohesion, dissolution percentage and density for 12 samples.

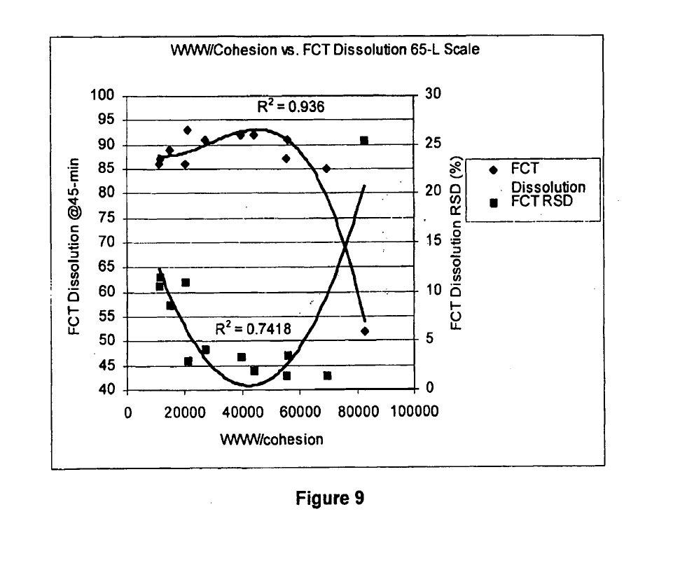

FIG. 9 describes a comparison between WWW/cohesion and tap density.

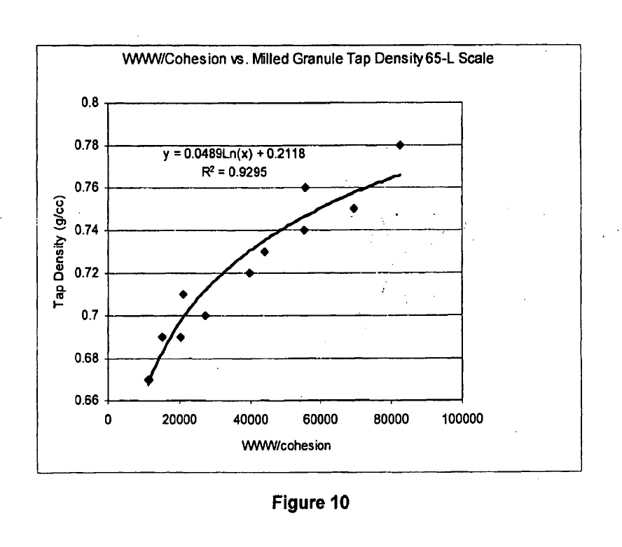

FIG. 10 describes a comparison between WWW/cohesion, dissolution percentage and density for 12 samples.

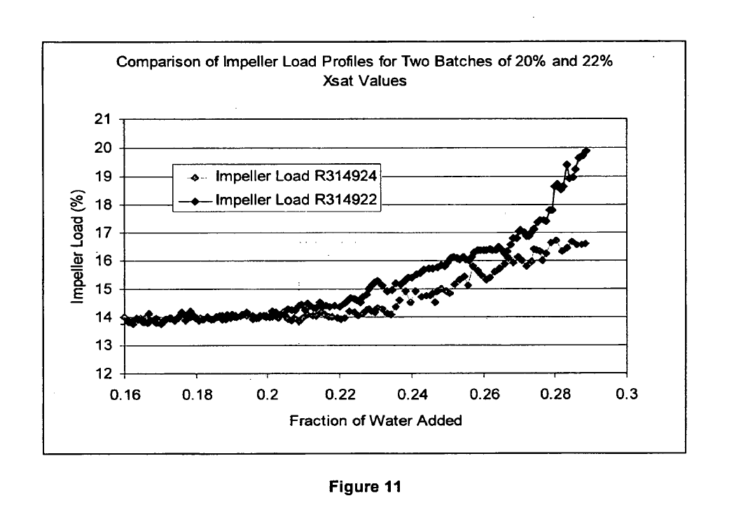

FIG. 11 describes Example of How Impeller Load Varies with Respect to Water Amount Added for Two Batches identified as having 20% and 22% Xsat.

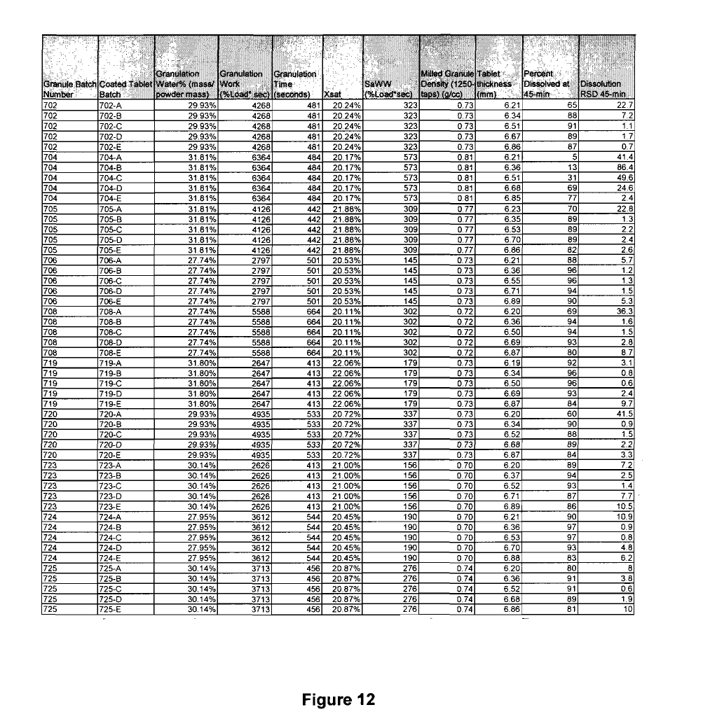

FIG. 12 describes a data table for granulation and compression DOE as related to SaWW Granulation Model.

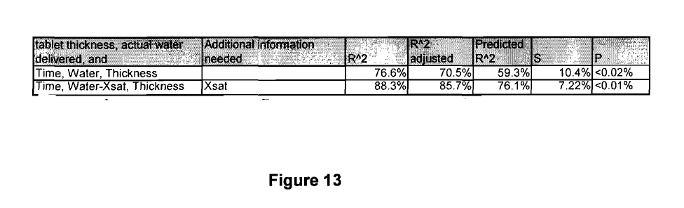

FIG. 13 describes a comparison of time+water based granulation endpoint model versus Time+Xsat based endpoint model.

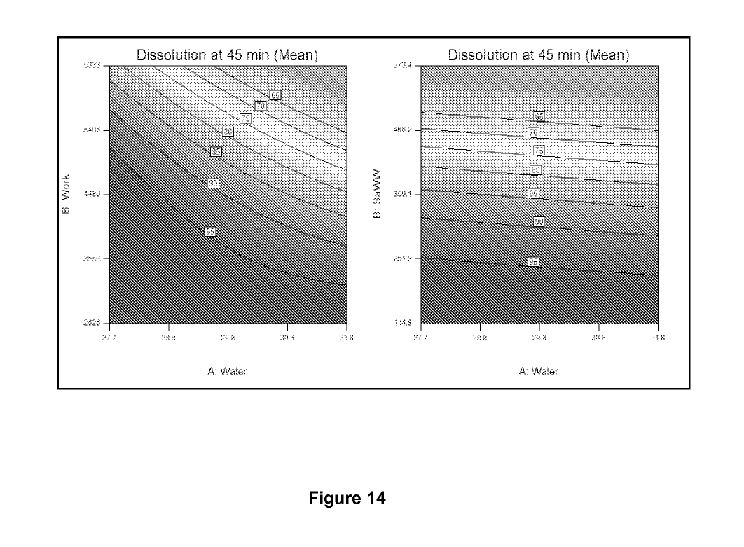

FIG. 14 describes a comparison of tablet dissolution response surface to work granulation endpoint model on left versus SaWW model on right. Surface is for a tablet thickness of 6.5 mm.

Table 15 describes a comparison of SaWW model to Work model for DOE data set and data set comprising all applicable data.

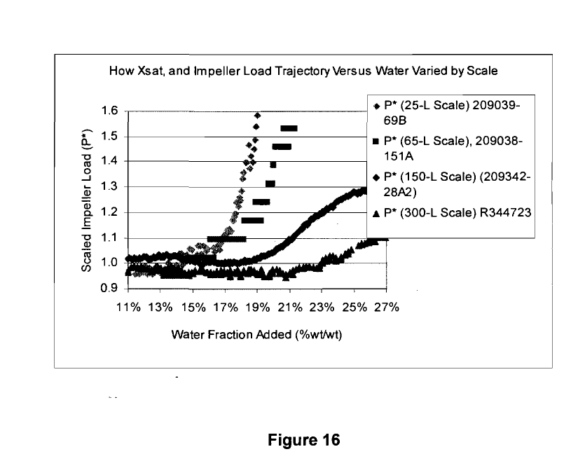

FIG. 16 describes a comparison of behavior of the Impeller load for batches at varying Scale, when plotted versus Water Fraction added.

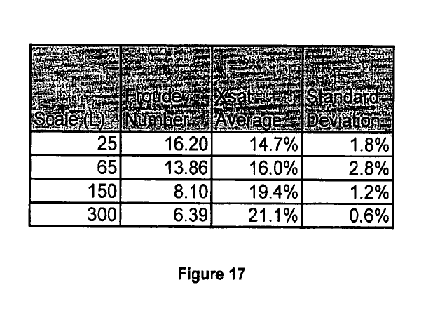

FIG. 17 describes observed values of Froude Number at each granulation scale, and average Xsat point for granulation batches with 5-minute water addition time, and for API micronized to within specification range for X90.

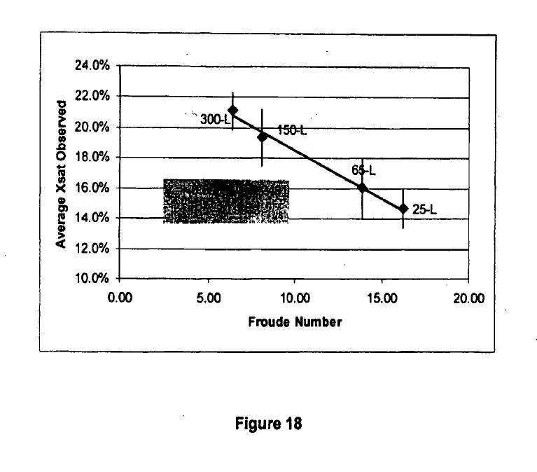

FIG. 18 describes the observed relationship between Froude Number and Average Amount of Water Needed to Saturate an API Formulation at each Scale; the figure also shows how the Froude Number appears to relate to the Average Amount of Water needed to start the granulation process (Xsat) at each scale (whiskers show range of data observed at each scale), the figure shows the observed relationship between Froude Number and average amount of water needed to saturate the formulation at each scale. The NFR=(r×N²×4×π²)/g, r=radius, N=RPM, g=acceleration due to gravity.

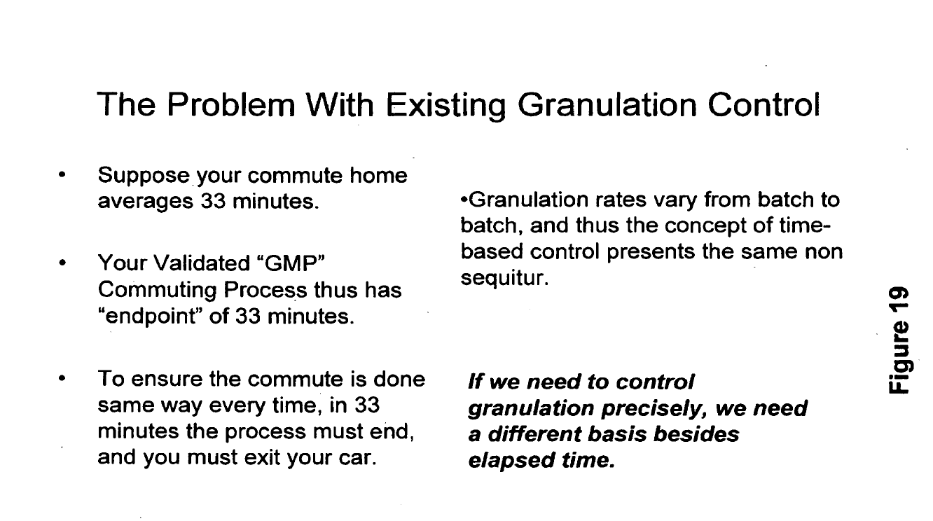

FIG. 19 describes problems with existing granulation control.

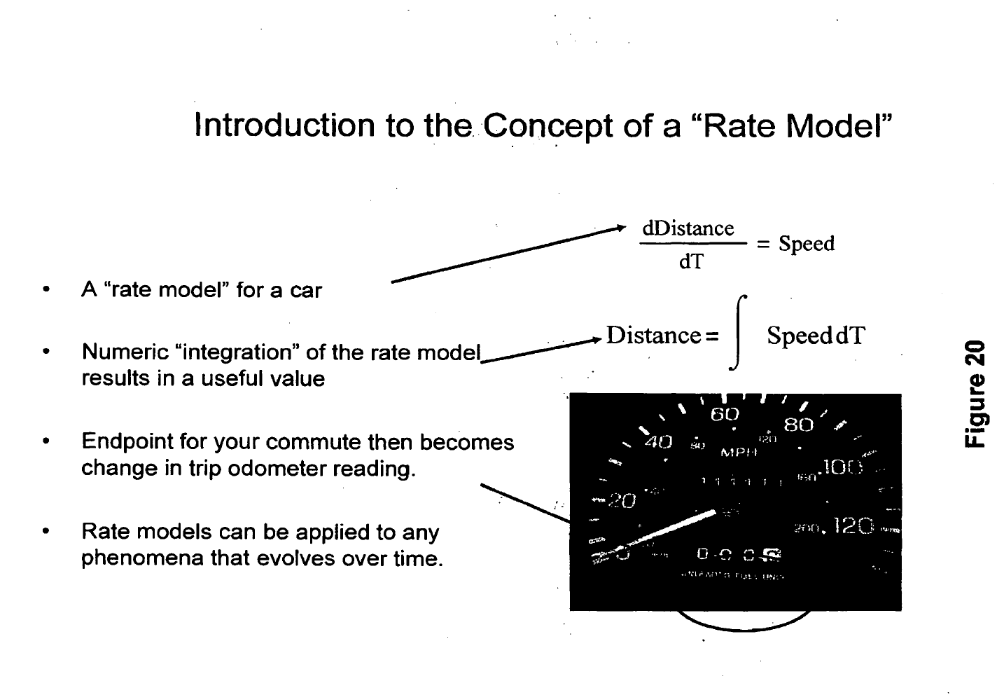

FIG. 20 describes concepts of the rate model.

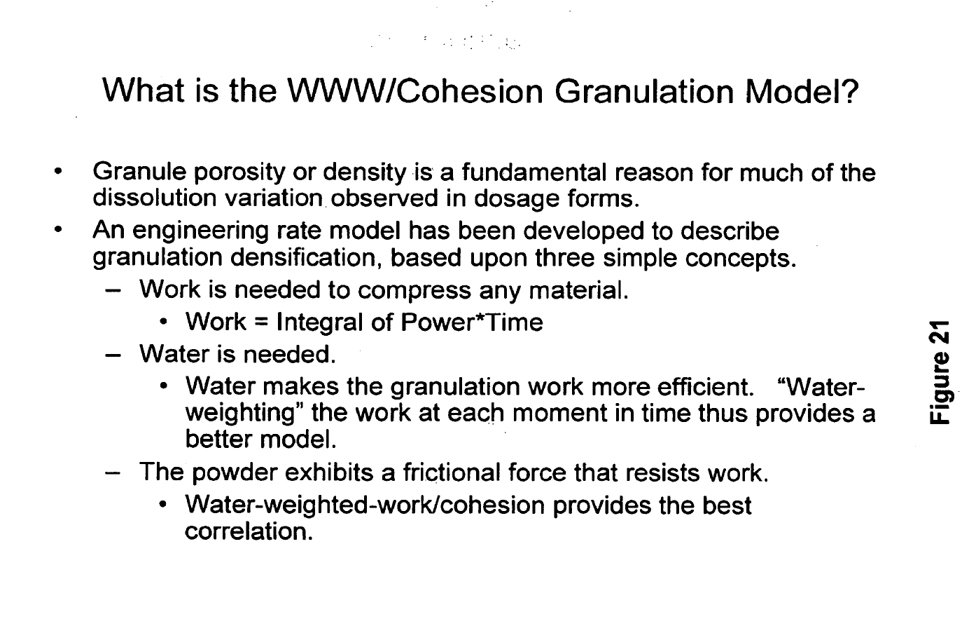

FIG. 21 describes the water weighted work/cohesion granulation model.

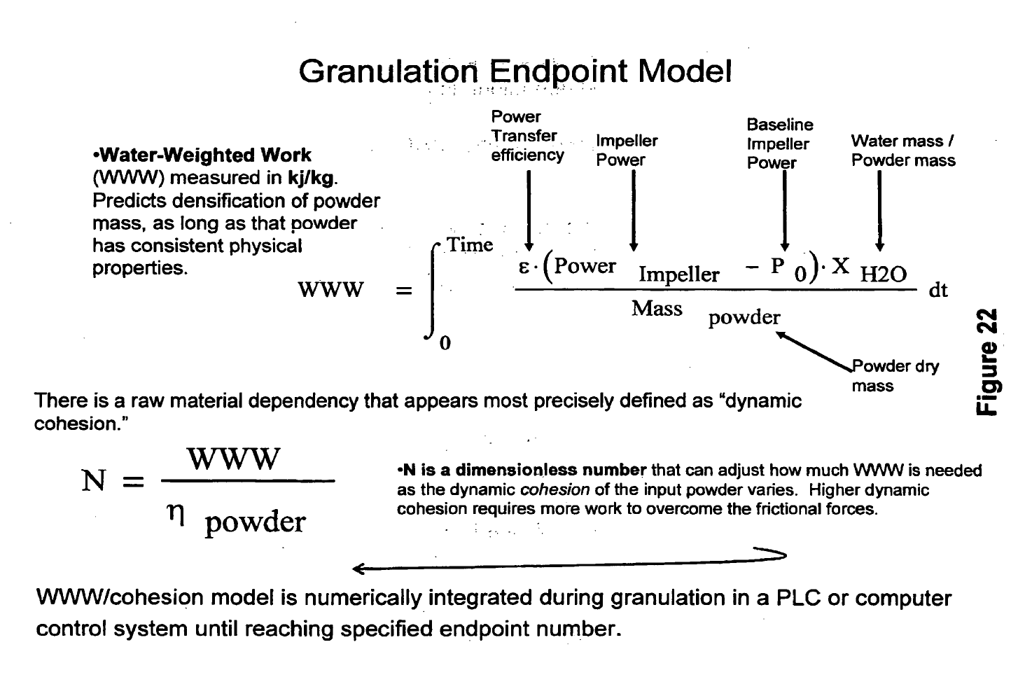

FIG. 22 describes the granulation endpoint model.

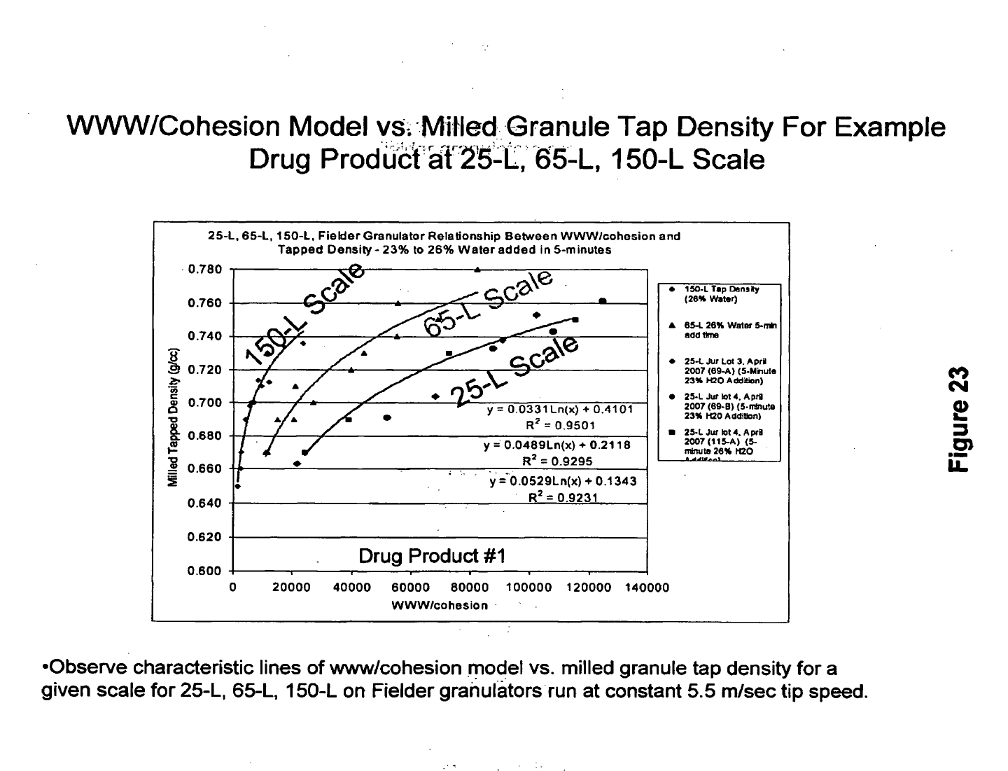

FIG. 23 describes water weighted work/cohesion granulation model versus tap density for three scaled lots, 25 L, 65 L and 150 L.

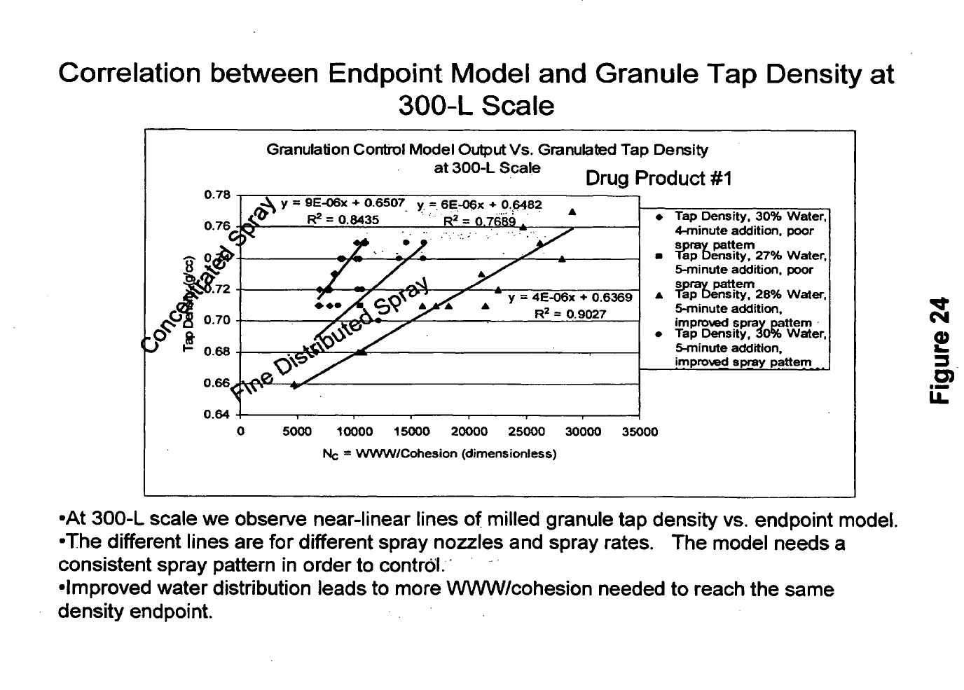

FIG. 24 describes correlation between endpoint model and tap density for product at 300 L scale.

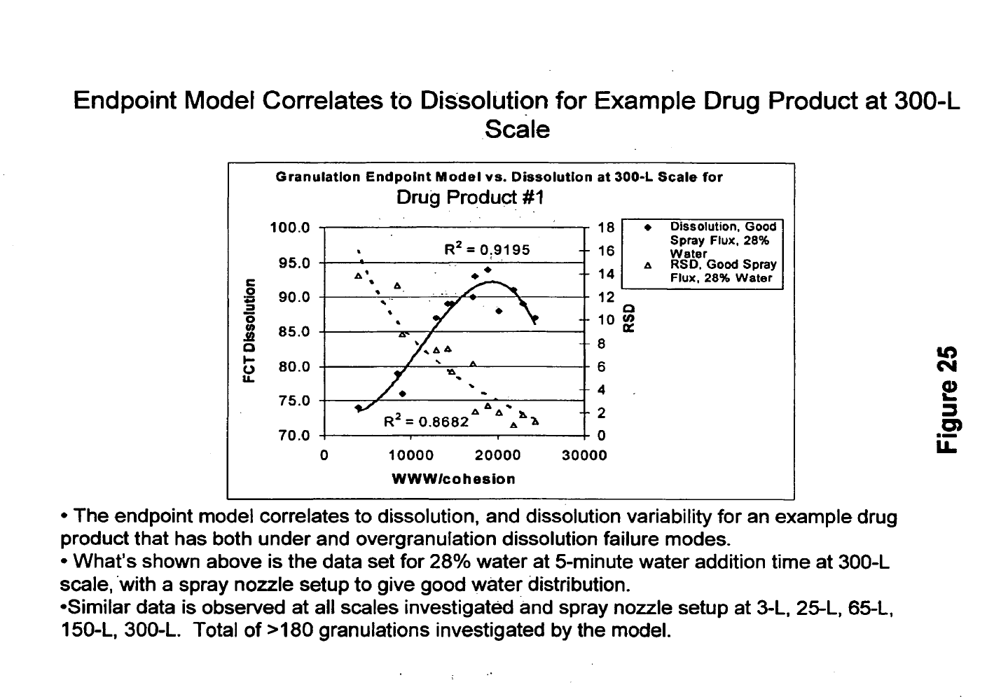

FIG. 25 describes endpoint model and correlation to dissolution for product at 300 L scale.

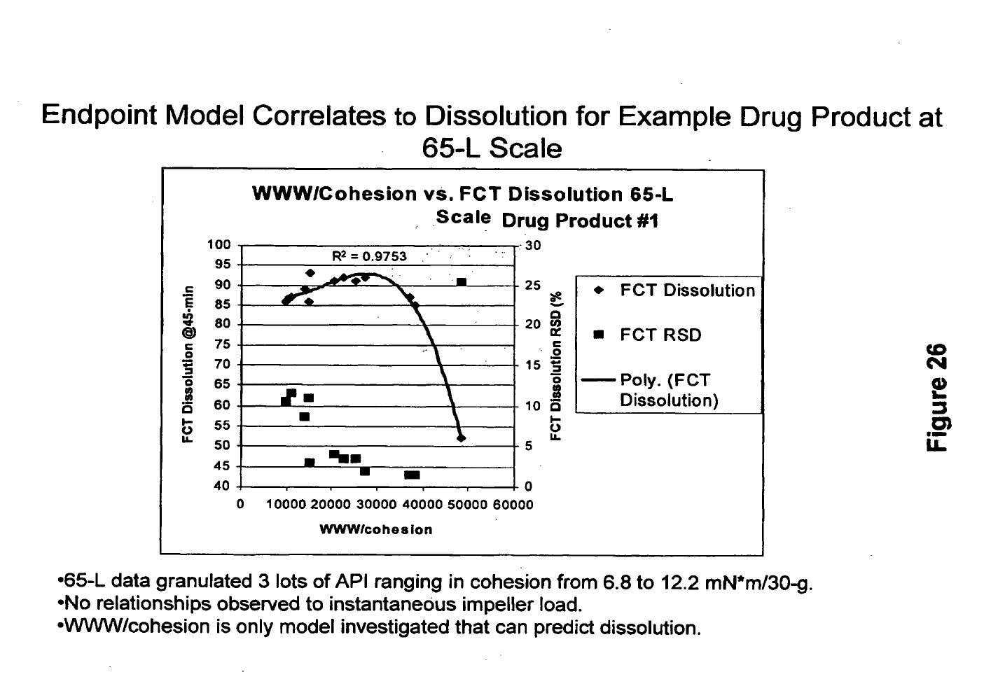

FIG. 26 describes endpoint model and correlation to dissolution for product at 65 L scale.

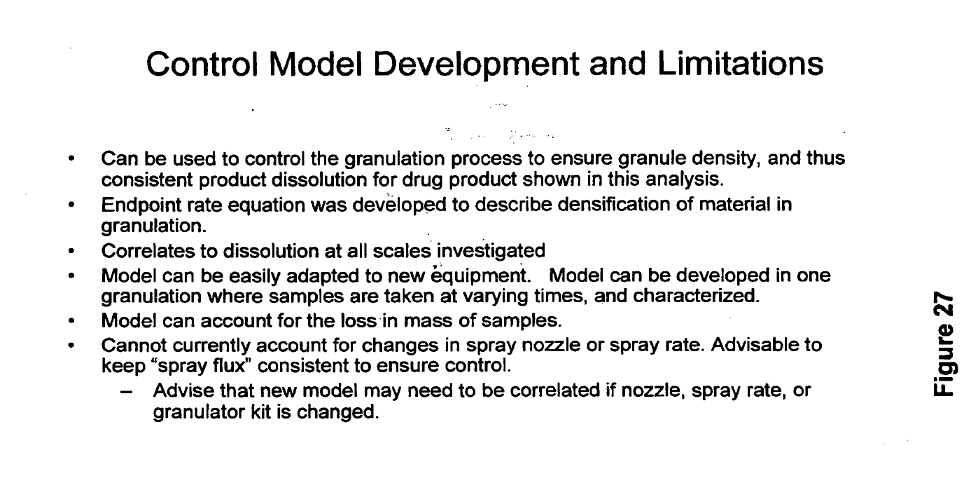

FIG. 27 describes control model development.

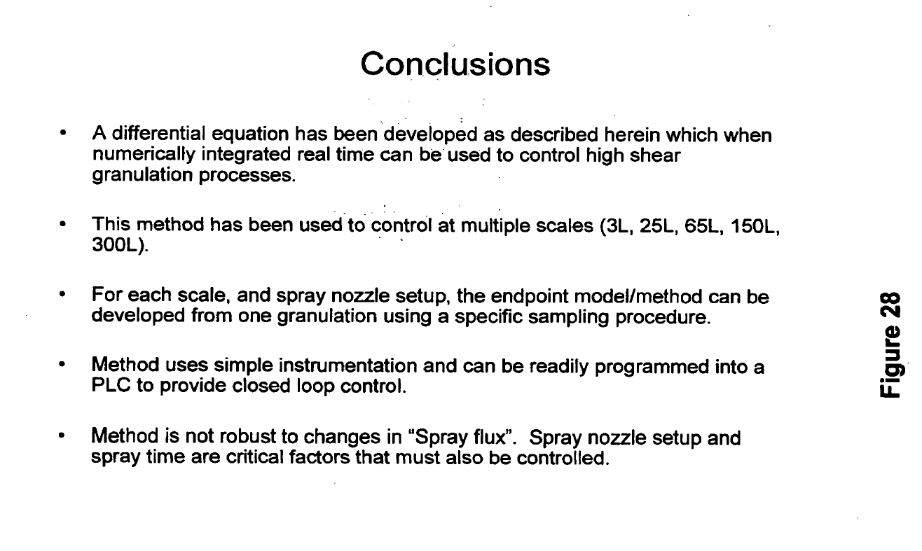

FIG. 28 describes conclusions of model/methods as used herein.

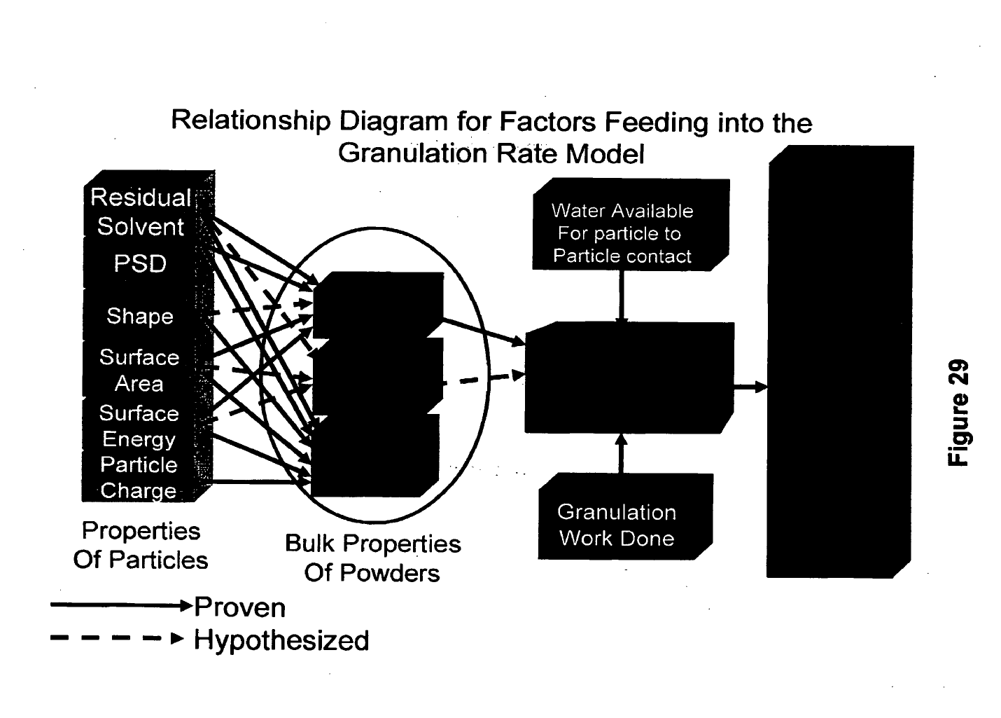

FIG. 29 describes a relationship diagram for factors in granulation rate model

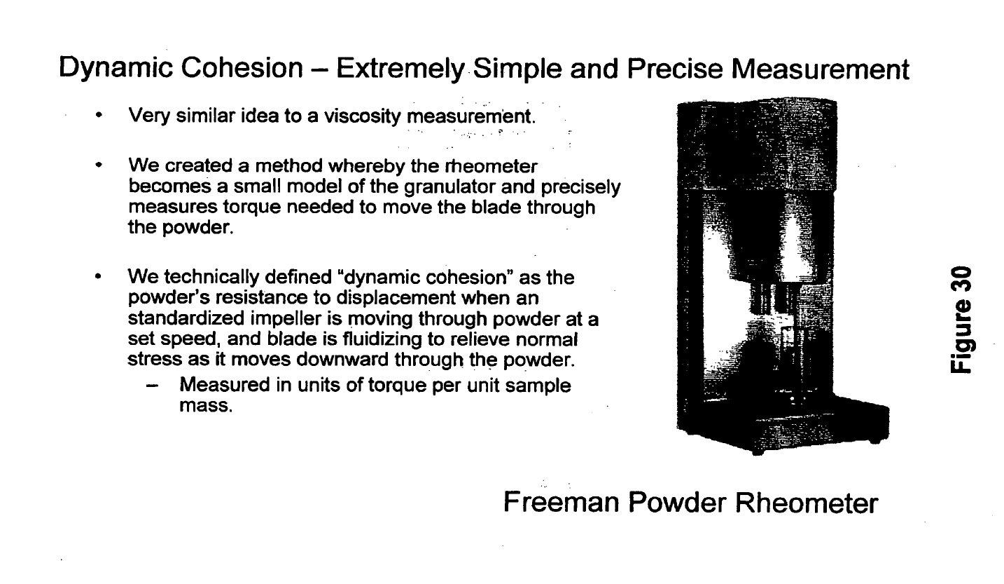

FIG. 30 describes dynamic cohesion.

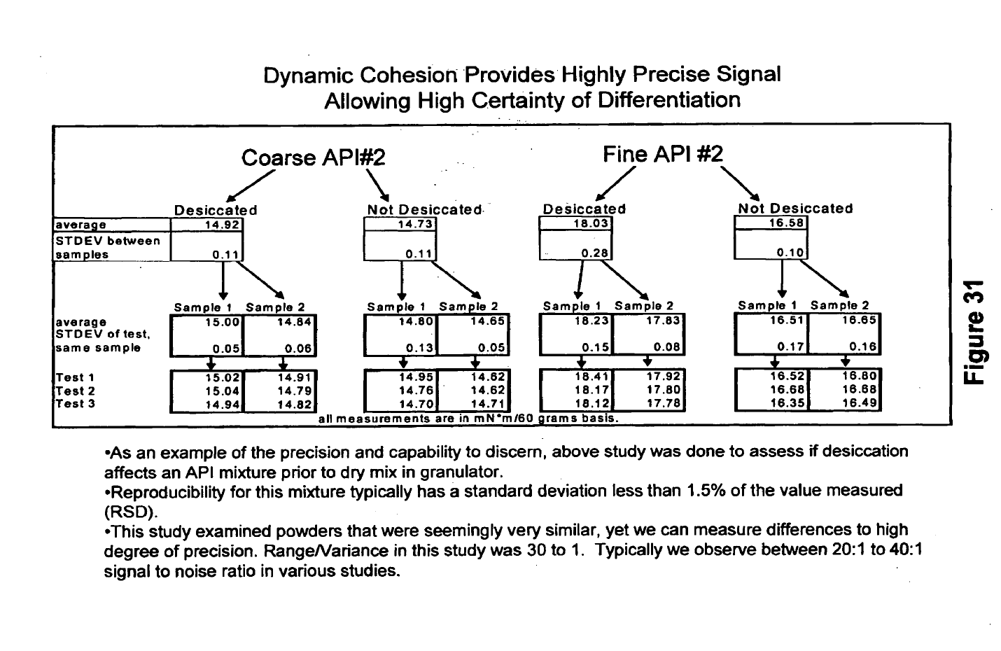

FIG. 31 describes dynamic cohesion with two different active pharmaceutical ingredients, both desiccated and nondesiccated.

### SUMMARY OF THE INVENTION

One aspect of the invention is a method for predicting when to stop granulating a material during a granulation process, comprising:

a) estimating the work imparted to the material by the impeller;

b) estimating the water fraction associated with the granulation process; and

c) predicting at least one of resulting granule density, resulting granule size, resulting granule porosity, resulting granule dissolution, bulk powder tap density, bulk powder density, estimated tablet dissolution, estimated tablet porosity, and/or estimated tablet porosity as a function of the estimated work and estimated water fraction.

Another aspect of the invention is an apparatus comprising a computer executable code stored on a computer readable medium for executing the above noted method.

Another aspect of the invention is an apparatus for controlling a granulator, comprising:

a controller operatively connectable to the granulator, the controller including a computer readable memory having stored therein a computer executable code for:

a) estimating the work imparted to a material by the impeller;

b) estimating the water fraction associated with the granulation process; and

c) predicting at least one of resulting granule density, resulting granule size, resulting granule porosity, resulting granule dissolution, bulk powder tap density, bulk powder density, estimated tablet dissolution, estimated tablet porosity, and/or estimated tablet porosity as a function of the estimated work imparted to the material and the estimated water fraction.

Another aspect of the invention is a system for controlling a granulation process, comprising:

a computer;

a user interface; and

a computer executable program stored in a computer memory device being capable of:

comparing data indicative of an amount of power input to the granulation process and data indicative of an amount of water added to the granulation process to predict an amount of work input to a material during the granulation process, and

determining an operating duration that the granulation process is to be operated to as a function of the predicted amount of work.

Yet another aspect of the invention is the system for controlling a granulation process, wherein the computer executable program is further capable of determining the operating duration based on the formula

SaWW=∫₀^{t}(Power_{Impeller}−P₀)·X_{S}dt

wherein Time is indicative of the operating duration, Power_{Impeller} is indicative of the amount power input to the granulation process, P0 is indicative of the baseline impeller load when no material is in the granulator, Xs is indicative of the amount of water above a critical amount defined as Xs=(X_{H2O}−X_{critical}), SaWW is indicative of the predicted amount of work input to the material during the granulation process if water amounts or material response to the water is changing.

### DESCRIPTION

High shear wet granulation is commonly used in pharmaceutical applications to agglomerate fine powders into more freely flowing granules. The extent of granulation may need to be precisely controlled in order to ensure acceptable granule size, granule density, compression characteristics, porosity, and/or tablet dissolution of the pharmaceutical material

A control system such as a Digital control system (DCS) or programmable logic controller (PLC) can be used to calculate the Work (as defined below in equation 1) and is applied to the powder mass by integrating the net power applied by the main impeller per unit time once water addition starts. Main impeller Work (equation 1) provides an effective control signal that can be used as real-time stopping criteria. The control is precise as long as the water amount, manner of water addition, and critical raw material physical properties do not change outside of acceptable limits. Response surface models to predict granule properties and tablet dissolution can be built by DOE varying Granulation Work, Water Amount, raw material physical properties, and compressed tablet thickness (such as described in FIG. 14).

Calculation of Work per unit mass (equation 1) in the granulator allows samples to be pulled at varying stages during the granulation process and related to non-sampled batches on a Work/mass basis. This provides an effective way to reduce raw material needs for DOE by approximately 75%.

The effects of raw material particle size variation has been explored by varying the upstream process of high shear granulation. Correlations were noted between the surface area, particle size distribution, and torque-per-unit-mass needed to turn an impeller through the powder mass as measured by a Freeman Powder Rheometer. Any of these three measurements of the input raw material could be used interchangeably in combination with granulation Work and granulation Water Amount to generate models that predict resulting granule density (FIG. 8) and tablet dissolution (FIG. 7). The simplest model was noted relative to the Rheometer results, suggestive that powder rheometry may provide a means of simplifying the understanding of granulation design space.

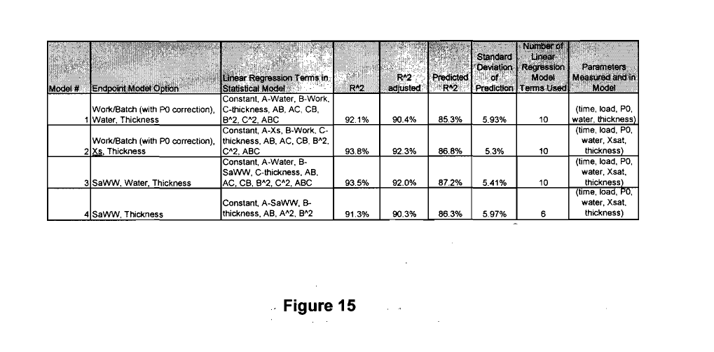

A more advanced differential equation for high shear granulation is proposed (equation 23), which considers net impeller power applied at each moment in time, multiplied by water amount added in excess (Xs) of amount needed to evoke a sustained impeller power response. Integration of this differential equation creates a value predictive of granulation outcome irrespective of water amount variation, and batch-to-batch variation in raw material response to the water addition. The amount of water necessary to evoke an impeller power response was found to be strongly linearly correlated to Granulation Froude Number across the four scales explored. Models considering Xs instead of absolute water amount were more predictive across scale for similar granulation equipment (FIG. 15). The equation functional form has now been found to be applicable across multiple products of varying ingredients and physical properties.

### Torque and Work

Most granulation endpoint techniques available in literature attempt to use the instantaneous observed value of the torque or impeller load (watts) as an “output” signal that predicts product characteristics. See Corvari V, et al. Instrumentation of a high-shear mixer: Evaluation and comparison of a new capacitive sensor, a watt meter, and a strain-gage torque sensor for wet granulation. Pharm Res 9(12):1525-1533, 1992; Holm P, Schaefer T, Kristensen HG. Granulation in high speed mixers. Part V: Power consumption and temperature changes during granulation. Powder Technol 43:213-223, 1985; and Holm P, Schaefer T, Kristensen HG. Granulation in high speed mixers. Part VI: Effects of process conditions on power consumption and granule growth. Powder Technol 3:286, 1993.

Thus, for such a technique, a specific impeller load or torque value is associated with the process timing of when to stop adding water, or the endpoint of the granulation process. The primary reason this technique appears so popular is motor load is easy to instrument, inexpensive, easy to observe, and may be, in limited circumstances, empirically correlated with product performance.

More elaborate granulation endpoint methods look to oscillations in the torque value and correlate such oscillations to changes in powder flow behavior. Another involves placing a strain gauge onto a probe within the granulating mass, and doing frequency and strain analysis of the resulting signal to relate granulation endpoint or scale-up. See Staniforth J N, Walker S, Flander P. Granulation monitoring in a high speed mixer/processor using a probe vibration analysis technique. Int J Pharm 31, 277-280, 1986.

One way to control granulation endpoint is by observing the cumulative power applied per unit mass, impeller load, or torque, and applying that observation to define when to stop the granulation. Work applied in granulation and relating the resulting material density may be measured by correlating total impeller work, normalized per unit mass of material, as determined via equation (1) and having units of watt*seconds/gram, to the bulk and tap densities as well as the compression profiles of granulated material.

$$Work = {\int }_{0}^{T} \frac{{Power}_{Impeller}}{{Mass}_{powder}} d t \qquad Equation ( 1 )$$

Equation (1) may be robust to changes in blade design and impeller speed and a correlation may exist between the granulation cumulative work and the resulting material that is independent of the granulator make, size and model. However, this type of control may not account for changes in raw material and/or water addition, nor may it clearly delineate the granulation design space.

Prior efforts that look at instantaneous torque or motor power values or other instantaneous instrument readings, see FIGS. 3, 4, 5, and 6, seem to create empirical models that can potentially be effective, but are not fundamentally describing the granulation phenomenon and are applicable only within the narrow range of operations. There may be other variables that affect torque or motor load besides the output product. Thus, when using these prior efforts to predict granulation, the process must be narrowly defined and may not be as robust or precise as it could be. As such, granulation may be a problematic operation for Pharmaceutical companies.

A method configured to predict and control the granulation process while accounting for changes in impeller load, water amount, water addition rate, and material changes is needed. The present disclosure is directed to overcoming one or more of the shortcomings described above.

### Water Weighted Work

Within the pharmaceutical industry, failed product made from granulated powders, e.g., dosage forms having undesirable dissolution rates or times, may occur due to variation in one or more of the following variables during granulation processes: water addition amounts, spray rate changes, feed material rheology variation, equipment changes, impeller design variation, and/or impeller speed variation.

Granulation may be performed on a given milled active pharmaceutical ingredient (API) via a granulator. A granulator is well known device in the art and as such is not further described. Granulation is a function of both water input and work done. Work done or transferred to the powder in the absence of water is not usefully applied to granulating the material. Similarly work done in presence of larger amounts of water results in rapid densification and less work is needed to reach the same density. Thus, work becomes increasingly important as water is added. Described in terms of a differential equation, the following rate equation may describe the densification of a powder mass as the water content varies at any moment in time as function of the power being applied and the water content or water fraction, X_{H2O}.

$$\frac{d ρ}{d t} = K \cdot \frac{{Power}_{Impeller} \cdot {X}_{H 2 O}}{{Mass}_{powder}} \qquad Equation ( 2 )$$

Evaluating equation (2) involves a numeric integration using the input values of the power applied at that moment in time, and the water fraction (X_{H2O}) at that moment in time in the powder mass, resulting in the following equation:

$$WWW = {\int }_{0}^{Time} \frac{( {Power}_{Impeller} ) \cdot {X}_{H 2 O}}{{Mass}_{Powder}} d t \qquad Equation ( 3 )$$

the value of which is referred to hereinafter as “water weighted work” (WWW) and having units of (watt*sec)/gram or joules/gram. Wherein Time may represent the time duration that the granulation process is operated and may have units of “seconds.” Mass_{Powder} may represent the dry mass of the material being granulated and may have units of “grams.” It is contemplated that equation (3) and one or more of the other equations described herein can be estimated, approximated, determined, and/or solved via any known method in the art such as, for example, numerical integration, summation, or other mathematical technique known in the art for performing an integration.

The water fraction X_{H2O} may represent the water content associated with the granulation process as a dimensionless fraction of water mass to powder mass at each moment of time during the granulation process, i.e., X_{H2O}=Mass_{water}/Mass_{Powder}. The water mass may be determined based on the following equation

Mass_{water}=Mass_{Powder}·Moisture_{Content}=∫₀^{Time}dWdt Equation (4)

where, Moisture_{Content} is a fraction representing the initial moisture content of the material prior to granulation and dW/dt represents the change in water with respect to time according to the following equation

$$\frac{d W}{d t} = {Addition}_{Rate} - {Evaporation}_{Rate} \qquad Equation ( 5 )$$

Addition_{Rate} represents the rate that water is added to the granulation process and may be observed as the change in scale weight for a tank holding water, metering pump, coriolis meter, and/or any other meting device known in the art. Evaporation_{Rate} represents the rate that water evaporates from the granulation process and may be determined using numerical methods to optimize the model. The evaporation rate can also be found by observing a reasonably significant sample set of Loss of Drying (“LOD”) or Karl Fischer values, each of which are well known in the art, for batches at varying elapsed times. It is contemplated that the rate that water evaporates from a granulation process may be significant if the seal purge air flow is significant and the process takes a significant amount of time. Batches granulated for longer elapsed times may be drier and less responsive to power input and batches that include more starts and stops and shorter massing times may be relatively more under-granulated at the same WWW value. Often power at the end of granulation has been added in short, e.g., 10 to 20 second, bursts of energy which may not be as efficient as compared to continuous application of energy. Batches where power is added in short bursts tend to have longer elapsed times and the drying effect, e.g., evaporation, should be accounted for. Additionally, equations (4) and (5) permit the evaporation rate to be 0 g/min and satisfy a null hypothesis criteria.

Power_{Impeller} may represent the power or work of the impeller that is transferred from the impeller blade to the material being granulated, may be determined via any suitable method, and may be, for example, expressed as a function of torque and RPM (revolutions per minute) of the impeller according to the following equations:

Power_{Impeller}=Torque·RPM Equation (6)

Powerᵢₘₚₑₗₗₑᵣ=(Torque·RPM−Torque₀·RPM) Equation (7)

wherein Torque and RPM are indicative of the torque and rotational speed of the impeller blade of the granulator when material is present in the granulator bowl, i.e., during the granulation process, and Torque₀ is indicative of the torque of the impeller blade of the granulator when the bowl is empty. Equation (6) may represent impeller power in terms that are more readily measurable or more easily sensed on the granulator and equation (6) as well as equation (7) may represent a more accurate measurement of actual power or work that is applied to the material by the impeller blade.

It takes a certain amount of motor power to turn the impeller with no material loaded in the bowl. That energy is being used within the power-train of the granulator and is not being transferred to the material in the bowl. As such, Power_{Impeller} may also be expressed as follows.

Powerᵢₘₚₑₗₗₑᵣ=(Power_{Impeller}−P0) Equation (8)

Where P₀ may represent the impeller load with no material in the bowl, at the RPM being used.

Impeller load efficiency may change with respect to elapsed time since restart. The impeller has to speed up from a stop, thus a significant amount of the energy will go into acceleration of the impeller and the powder mass, and will not be used to densify the material in the granulator. Two effects may affect impeller efficiency. The first effect, defined as “Y” measures the “half life” of efficiency increase, i.e., every Y seconds, the efficiency gets 50% closer to the maximum possible. The second effect defined as “X”, assumes the granulator has a harder time speeding up when the frictional interaction of the granules is high and the impeller loads are high. The following equation describes these effects

$$ɛ = 100 \% - {[ 50 \% \cdot {( \frac{{P}_{impeller}}{50} )}^{X} ]}^{\frac{Time}{Y}} \qquad Equation ( 9 )$$

where 50 represents the maximum impeller load observed, ε is the impeller efficiency, and “time” is the time since restart. It can be shown that if the granulator does not take more time to speed up when the impeller power is high, then X will approach zero. As X approaches zero, the term Pᵢₘₚₑₗₗₑᵣ/50 approaches 1 and the value inside the brackets is 50%. Similarly if elapsed time since restart is not important, then the value of Y will approach zero, and the efficiency will always be 100%. Combining equations (3) and (9) establishes the following equation. It is contemplated that equation (9) may alternatively be expressed as ε32 100−(50%)̂(Time/Y) or via any suitable half-life equation known in the art.

$$WWW = {\int }_{0}^{Time} \frac{ɛ \cdot ( {Power}_{Impeller} ) \cdot {X}_{H 2 O}}{{Mass}_{Powder}} d t \qquad Equation ( 10 )$$

It is contemplated that equation (3) may account for affects of water addition rate changes, and water addition amount changes. Hence, process control apparatus and methods implementing equation (3), alone or in combination with Equations (6)-(8) may more accurate than conventional apparatus and methods implementing equation (1) and process control apparatus and methods implementing equation (10), alone or in combination with equations (6)-(8) may be more accurate than those implementing equation (3). Both equations (3) and (10) may account for changes in the granulation process occurring due to water amount, water addition rate, and granulation power input during a granulation process. However, equations (3) and (10) may not account for the variability in a granulation process due to raw material changes.

### Dynamic Cohesion

If a material's physical property is directly affecting the process, it may be better to directly measure it rather than indirectly infer it from some other measurement as long as the direct measurement can be done precisely. In a process occurring on a scale as large as granulation, variation in something on a scale as small as particle size of the input material cannot be directly observed. The particles are 5 to 6 orders of magnitude smaller than the impeller blade, and 2 to 3 orders of magnitude smaller than the water droplets and neither the impeller blade nor the water droplets are on a scale that can directly observe the particle size. Microscopic particle size variation may affect the bulk properties of the powders. Bulk property variations such as, for example, frictional interaction between particles, density, and wetting angle, may affect the large scale granulator and/or granulation process and may correlate to observations of materials granulating differently.

The use of dimensionless numbers is well known in the art for correlation based upon the observation that all motivating forces are countered by an opposing force such as friction or gravity, e.g., the “Reynold's number” and the “Mixing Reynold's Number” which describe flow and mixing behavior in fluids. Most dimensionless numbers can be thought of as the motivating forces divided by the frictional or gravitational forces which operate within the same units and length scale to resist the motivating forces.

“Cohesion” conventionally refers to the ability of a material to join or “stick” to itself and is generally a frictional force that resists forces moving against it, such as, for example, gravity. Powder materials also exhibit a “cohesion” property that resists the motivating force in the granulation process. This “cohesion,” with respect to powders, may be similar to viscosity, with respect to liquids. Thus, as powder “cohesion” increases, more granulation work and water may be required to achieve the same granulation endpoint. As particles are milled more finely, the number of particles increases in the powder, the interactions between particles increase, and the total surface area increases, each affecting a more “cohesive” powder. Therefore, changes in cohesion of a powder material can have significant affects on the granulation process.

Previous methods to determine “cohesion” of a powder have measured the force needed to separate a compressed bed of powder. See U.S. Pat. No. 3,693,420 which is incorporated herein by reference. Although this method may be useful for predicting the tableting characteristics of the material, it may not be suitable to predict the “cohesion” of an un-compressed powder. Additionally, this method may be unsuitable for predicting the cohesion as particles of a powder interact with one another during a granulation process. At present, there is not a suitable method for determining the “cohesion” of particles with one another within an un-compressed powder material.

Accordingly, a method is provided herein for determining “dynamic cohesion” for a powder material, which may represent a close analogy to viscosity for liquid. Dynamic cohesion may be determined via a torque rheometer. A torque rheometer is a device well known in the art and is described in U.S. Pat. No. 6,065,330 to Freeman et al., which is incorporated herein by reference. Dynamic cohesion may be indicative of the energy needed to move an impeller blade of known dimension and tip speed when a known mass of material is suspended above the blade. Dynamic cohesion may be determined when the material is at a substantially consistent packing, substantially un-fluidized, and not under substantial compressive stresses. Dynamic cohesion has units of “Newton*meter/gram” or “joules/gram.”

In accordance with an embodiment of the present disclosure, a method and apparatus for determining dynamic cohesion are provided. The method may include loading a powder material into a rheometer bowl via any method known in the art. The resulting density of the powder is dependent upon how an operator loaded the material in the bowl. For example, an operator may sift the material, may pat-down the material, or may scoop the material into the bowl, each of which may establish different densities of the powder. The method may also include conditioning the powder to achieve a standard state density. The rheometer blade may be controlled to progress through the material to either aerate a compacted material or de-aerate a sifted material and may standardize the powder regardless of how it was loaded into the rheometer bowl. It is contemplated that conditioning the material may include controlling the blade to enter the material, pass through the material in a helical pattern, and exit the material any number of times. It is also contemplated that the blade may be controlled to pass through the material until a relatively repeatable blade torque is observable. In an exemplary embodiment, conditioning the material may include passing the blade through the material ten (10) times.

The method may also include monitoring toque measurements of the blade at a given depth of the material. For example, after the material has been conditioned, the impeller blade may be controlled to again pass through the material and the torque that is being applied to the impeller blade at a given height of the material may be observed and/or recorded. It is contemplated that the torque may be monitored for any number of trials. In an exemplary embodiment, the torque applied to the blade may be observed at a material height of 10 mm. It is contemplated that any statistical analysis, e.g., averaging, may be utilized to establish a value indicative of the torque applied to the blade at the given height as a function of the plurality of torque observations in order to mathematically combine such observations.

The method may also include establishing the dynamic cohesion as a function observed torque and the mass of the material within the bowl. That is, dynamic cohesion, represented hereinafter as (η) may be determined by dividing the observed torque of the impeller blade by the mass of the material loaded into the bowl establishing units of Newton-meter (torque) per grams (mass) (Nm/g), or Joules/g. It is contemplated that the method described above for determining dynamic cohesion may more precisely predict the frictional interactions between particles within a powder and thus may more accurately predict such interactions during a granulation process than method determining cohesion based on the force needed to separate a compressed bed of material, e.g., as described in U.S. Pat. No. 3,693,420.

Combining equation (1) with equation (9), to account for impeller efficiency, and accounting for dynamic cohesion, represented hereinafter as either η or η_{powder} provides the following equation:

$$WPC = {\int }_{0}^{Time} \frac{ɛ \cdot ( {Power}_{Impeller} )}{{Mass}_{Powder} \cdot η} d t \qquad Equation ( 11 )$$

where η represents dynamic cohesion and “WPC” may represent the power added to the material during the granulation process as a function of dynamic cohesion. It is contemplated that equation (11) may be combined with any of equations (6)-(8) and may be modified so as to not account for impeller efficiency, i.e., ε may optionally be removed from equation (11) such as, for example, when a granulation process is running without stops, when some degree of imprecision is acceptable, and/or when merely scaling granulation equipment. It is contemplated that equation (11) may account for variability in the physical properties of an input raw material and may be suitable to predict granulation when there are substantially no variations in the amount of water and/or the water addition rate for the process.
Water Weighted Work with Dynamic Cohesion

A dimensionless equation is observed when the water weighted work from Equation (3) is divided by the dynamic cohesion value η_{powder} of the material and provides in the following equation.

$$WWW = {\int }_{0}^{Time} \frac{( {Power}_{Impeller} ) \cdot {X}_{H 2 O}}{{Mass}_{Powder} \cdot η} d t \qquad Equation ( 12 )$$

Equation (12) may represent the ratio of input power in granulation, as weighted by water content, divided by the dynamic cohesion of the input material and may be suitable to predict the density of material being granulated regardless of changes in water addition time, amount, or input material cohesion.

Combining equations (8) and (12) to account for lost impeller power, P₀, provides the following equation.

$$WWW = {\int }_{0}^{Time} \frac{( {Power}_{Impeller} - {P}_{0} ) \cdot {X}_{H 2 O}}{{Mass}_{Powder} \cdot η} d t \qquad Equation ( 13 )$$

The difference between Equation (12) and equation (13) may be subtle because the contribution of P₀ to equation (8) may be small, however, removing the energy going into the power train and, thus, not going into the material, may improve accuracy. The lost energy, i.e., P₀, may be significantly larger in experiments that run for relatively longer times, which may have larger power offset compared to experiments running for relatively shorter times, and accounting for P₀ via equation (13) may substantially improve accuracy for these experiments. It is contemplated that equation (12) may alternatively be combined with equation (6) or equation (7). Additionally, equations (9) and (12) may be combined to account for impeller efficiency according to the following equation.

$$WWW = {\int }_{0}^{Time} \frac{ɛ \cdot ( {Power}_{Impeller} ) \cdot {X}_{H 2 O}}{{Mass}_{Powder} \cdot η} d t \qquad Equation ( 14 )$$

A dimensionless number that may predict granulated material properties such as, for example, resulting granule density, resulting granule size, resulting granule porosity, resulting granule dissolution, bulk powder tap density, bulk powder density, estimated tablet dissolution, estimated tablet porosity, and/or estimated tablet porosity if the material has varying cohesion can be defined as

$${N}_{C} = \frac{WWW}{{η}_{powder}} \qquad Equation ( 15 )$$

where WWW represents the water weighted work according to, for example, equation (14) and N_{C} may correlated to one or more of the material properties stated above after the granulation process as is described more fully below. In practice, it may be more convenient to separate equations (14) and (15) into separate values for purposes of model validation.

Equations (14) and (15) may be used to predict an endpoint of a granulation process and/or to control a granulation process to achieve one or more of the following properties: resulting granule density, resulting granule size, resulting granule porosity, resulting granule dissolution, bulk powder tap density, bulk powder density, estimated tablet dissolution, estimated tablet porosity, and/or estimated tablet porosity. For example, it may be desirable to produce dosage forms, e.g., tablets, from granulated micronized materials such that the dissolution of the tablet is within a predetermined range.

A method to predict the endpoint or to control the granulation process may include determining the dynamic cohesion of the micronized powder as described above. The method may also include granulating the powder and obtaining one or more samples of granulated material at one or more times during the granulation process. For example, the granulation process may be stopped and a sample of the granulated material as of that time duration may be taken. It is contemplated that four samples may be obtained.

The method may also include determining the water weighted work associated with each sample. For example, the water weighted work may be determined by calculating, determining, estimating or approximating equation (14) and/or equation (15) via any suitable method known in the art, such as, for example, numerical integration or summation techniques. The method may also include determining one or more of the material properties, e.g., resulting granule density, resulting granule size, resulting granule porosity, resulting granule dissolution, bulk powder tap density, bulk powder density, estimated tablet dissolution, estimated tablet porosity, and/or estimated tablet porosity, for each of the samples. It is contemplated that the one or more material properties may be determined via any suitable method known in the art, such as, for example, via one or more United States Pharmacopoeia (USP) publications. The method may also include correlating the determined WWW, via equation (14) or N_{C}, via equation (15) and the determined one or more properties to one another for each of the one or more samples. It is contemplated that this correlation may be a numeric correlation, may include one or more data maps, and/or may include any type of correlation known in the art. The method may also include determining a given relationship between the determined WWW and/or N_{C} and the properties based on the one or more samples. It is contemplated that interpolation, extrapolation, curve fitting, and/or any other mapping function may be used to determine such a relationship. The method may also include functionally relating a WWW and/or N_{C} value to a selected material property via the determined relationship, i.e., the determined relationship may functionally relate material properties with WWW and or N_{C} values.

The material may then be granulated while monitoring the water weighted work associated therewith and the granulation process may be stopped when a given amount of WWW or N_{C} has been transferred to the material to thereby achieve a desired granulated material property. For example, a given tablet dissolution may be selected as a function of, e.g., a desired dosage release timing and/or any suitable criteria, and functionally related via the determined relationship to a given WWW and/or N_{C} value. The granulation process may be operated and the water weighted work transferred to the granulated material may be monitored during the process and the process may be stopped when the monitored WWW and/or N_{C} is substantially equal to the WWW and/or N_{C} value and/or within a predetermined range thereof. It is contemplated that the granulation process may be operated for discrete periods of time, the amount of WWW and/or N_{C} that associated with the material up to that point during the granulation may be determined, and the amount of time the granulation process may still need to be operated may be determined as a function of the difference between the determined WWW and/or N_{C} value and the monitored WWW and/or N_{C} value. It is contemplated that any criteria may be used to determine the time duration that the granulation process may still need to be operated to transfer additional water weighted work to the material, including, for example, dividing the granulation process into discrete time durations and progressively operating the granulation process for additional time durations, estimating a subsequent time duration as a function of an averaged amount of water weighted work transferred to the material for one or more previous time durations, and/or any other suitable method. It is also contemplated that the operation time for the granulation process to transfer the given amount of water weighted work may be estimated or otherwise determined via, for example, equation (15), the granulation process may be operated continuously and stopped after the determined time duration has lapsed.

Equations (14) and (15) may be used to predict the time the material is to be subjected to the granulation process to achieve a desired material property thereof. As such, the granulation process may be stopped at the predicted time and the dissolution timing of a dosage form made from the granulated API may be within a desired range. Thus, controlling a granulation process according to equations (14) and (15) may reduce the occurrences of failed dosage forms, i.e., dosage forms that have a material property, e.g., dissolution rate, outside a predetermined and/or desired range, by more accurately predicting the operation of the granulation process.

### Additional Variables

It is contemplated that dynamic cohesion may be replaced with specific surface area SSA in one or more of the equations set forth above such as, for example, equations (11) and/or (14). Specifically, replacing dynamic cohesion η in equation (11) may provide the following

$$WPSSA = {\int }_{0}^{Time} \frac{ɛ \cdot ( {Power}_{Impeller} )}{{Mass}_{Powder} \cdot SSA} d t \qquad Equation ( 16 )$$

wherein SSA may be determined by any suitable method such as one or more methods described in one or more USP publications and/or may include a BET calculation. Also, replacing dynamic cohesion η in equation (14) may provide the following

$$WWWPSSA = {\int }_{0}^{Time} \frac{ɛ \cdot ( {Power}_{Impeller} ) \cdot {X}_{H 2 O}}{{Mass}_{Powder} \cdot SSA} d t \qquad Equation ( 17 )$$

which may have units of power input per unit surface area of powder. It is contemplated that equations (16) and (17) may be respectively less accurate than equations (11) or (14) in predicting a granulation process. Additionally, other material properties that correlate with dynamic cohesion and/or specific surface area may be substituted for dynamic cohesion in one or more of the equations set forth above such as, for example, equations (11) and (14). For example, the following proportionalities may exist within powder systems and may be substituted if the precision requirements and control of the granulation process permit:

$$η = f ( \frac{1}{PSD} ) \qquad Equation ( 18 )$$

where PSD represents the particle size diameter of the powder and equation (18) represents dynamic cohesion represented as a function of the inverse of PSD,

η=f(SSA) Equation (19)

where equation (19) represents dynamic cohesion as a function of specific surface area,

$$η = f ( \frac{1}{{ρ}_{bulk}} ) \qquad Equation ( 20 )$$

ρ_{bulk} represents the bulk modulus of the powder and equation (20) represents dynamic cohesion as a function of the inverse of bulk modulus,

$$η = f ( \frac{1}{{ρ}_{tap}} ) \qquad Equation ( 21 )$$

where ρₜₐₚ represents the tap density of the powder and equation (21) represents dynamic cohesion as a function of the inverse of tap density. It is contemplated that any of equations (18)-(21) may be substituted for dynamic cohesion in any of the equations set forth above, where applicable. It is also contemplated that an equation, in which dynamic cohesion is substituted for one of equations (18)-(21), may be a relatively less accurate method of predicting a granulation process as compared to an equation set forth above that accounts for dynamic cohesion.

Furthermore, water spray droplet size and spray spatter may have substantial effects in the granulation process. A dimensionless number conventionally referred to as “spray flux,” which is a ratio of the water spray coverage per unit of powder bed area passing under the spray nozzle, is known in the art. For example, spray flux is described in Litster J. D. 1; Hapgood K. P.; Michaels J. N.; Sims A.; Roberts M.; Kameneni S. K.; Hsu T; “Liquid distribution in wet granulation: dimensionless spray flux”, Powder Technology, Volume 114, Number 1, 15 Jan. 2001, pp. 32-39(8) which is incorporated herein by reference. Spray flux may be more of a problem at larger scales because the water spray becomes less adequately distributed and thus the process becomes more dependant upon “chopper” to distribute the water during water addition. See Litster J. D. 1; Hapgood K. P.; Michaels J. N.; Sims A.; Roberts M.; Kameneni S. K.; Hsu T; “Liquid distribution in wet granulation: dimensionless spray flux”, Powder Technology, Volume 114, Number 1, 15 Jan. 2001, pp. 32-39(8).

It is contemplated that relatively larger water droplets may increase the consolidation of a powder as compared to relatively smaller water droplets and that less work may be needed to granulate a material having a spray pattern including larger water droplets, i.e., a consolidated or “less-fine” spray pattern. Additionally, it is contemplated that a granulation process may be affected by the wetability of the powder material, wherein wetability is conventionally known as the process when liquid spreads across a solid substrate and can be estimated by determining the contact angle or conventionally referred to spreading coefficient.

It is contemplated that there may be a lower limit of water content, below which the method may be less accurate. A certain amount of water is needed to hydrate the binder and the disintegrant. As an alternative, the X_{H2O} variable may be expressed as the amount of water above a certain saturation threshold. It is also contemplated that there may be an upper limit to the particle mass being granulated, above which the method may be less accurate. Cohesion decreases with increasing particle size making it easier to granulate the material, but at some point with increasingly more massive particles, more binder may be necessary to adhere the particles together. Changes in spray flux may result in a different correlation line for the tap density versus WWW being calculated. Other affects that influence water distribution, such as soak time between the water addition and massing might also affect the accuracy of the method.

The equations for water weighted work set forth above such as, for example, equations (3), (12)-(14), and (16) may each be made more robust to changes in water addition amount or water spray rate by accounting for the amount of water needed to saturate the surfaces of the material (Xₛₐₜ) as follows:

$$WWW = {\int }_{0}^{Time} \frac{ɛ \cdot ( {Power}_{Impeller} ) \cdot {( {X}_{H 2 O} - {X}_{Sat} )}^{Z}}{{Mass}_{Powder} \cdot η} d t \qquad Equation ( 22 )$$

Equation 22 can be referred to in this art as the “Saturated Weighted Work” or SaWW model. In a typical situation where input material physical properties, and batch size are being held consistent, Equation 22 can be simplified to Equations 23 and 24. Equation 23 is useful for predicting Work necessary when water amount or how raw material is responding to water addition is a significant source of variability.

SaWW=∫₀^{t}(Power_{Impeller}−P₀)·X_{S}dt Equation (23)

where Xₛ is the amount of water above the saturation point, which is defined as

X_{S}=(X_{H2O}−X_{SAT}) Equation (24)

where Xₛₐₜ may represent the amount of water needed to saturate the components of the mixture that absorb water and thus remove water from participating in the granulation process, or the amount of water needed to saturate the entire mixture. Xsat can be determined online as the amount of water that needs to be added to the granulation process before the impeller load starts to increase.

Xsat may also be correlated to specific surface area (SSA), or particle size distribution (PSD), or gravimetric vapour sorption (GVS) analysis at ambient temperature. GVS, SSA, and PSD analyses are well known in the art and is not further described. It is contemplated that these values may be substantially equally applicable to predict Xsat for use in equation (22). Also, the exponent Z may represent the non-linear effect of water and may be determined via data optimization. It is contemplated that Z may be a positive value between zero (0) and ten (10).

Alternatively, the water saturation effect may also be represented as the change in viscosity of the binder solution in the granulator as more water is added to the system which may provide the following

$$WWW = {\int }_{0}^{Time} \frac{ɛ \cdot ( {Power}_{Impeller} )}{{Mass}_{Powder} \cdot η \cdot {μ}_{solution}} d t \qquad Equation ( 25 )$$

where μₛₒₗᵤₜᵢₒₙ represents the viscosity functionality of the binder and soluble components of the granulation process, e.g., the mixture, as a function of the water available to hydrate the mixture and the mixture temperature, i.e., μₛₒₗᵤₜᵢₒₙ=f{(X_{H2O}−Xₛₐₜ), Temperature}. It is contemplated that equations (23) and (25) may be more robust to changes in water than equations (3), (12)-(14), and (16).

### Method of Operating a Granulation Process

A typical granulation process includes a mixer bowl, powder, water, and means to blend the materials together, and means to add water and powder. As such, a granulation process is known in the art and is not further described herein.

The method described above may be performed as one or more steps to predict, and hence control, the endpoint of a granulation process when the cohesion of a material, e.g., an API, may not be significantly varying and may predict the density of the granulated material. The method may include a step to determine the powder mass densification of the powder mass as the water content varies via equation (2). The method may also include a second step to determine the water weighted work (“WWW”) via equation (3). The method may also include a step to determine the water fraction of the granulation process, e.g., for use within equation (3), via equations (4) and (5). The method may also include a step to determine the impeller power via any of equations (6)-(8), e.g., for use within equation (3) and/or the impeller efficiency via equation (9). The method may also include a step to determine WWW via equation (10).

The method may also include a step to determine dynamic cohesion via the method described above. It is contemplated that determining dynamic cohesion may be done independently or in conjunction with determining WWW via any of the equations set forth above or controlling a granulation process as a function thereof. The method may also include a step to determine the ratio of input work to dynamic cohesion via equation (11).

The method may also include a step to determine WWW and accounting for dynamic cohesion of the input material via equation (12). The method may also include a step to determine WWW accounting for dynamic cohesion of the input material and accounting for the energy of the impeller that is directed to the impeller drive train and not to the granulation of the input material via equation (13). The method may also include a step to determine WWW accounting for dynamic cohesion and impeller efficiency via equation (14). The method may further include predicting the endpoint when the cohesion of the API is not significantly varying via any one of equations (3), (10)-(14) and may include predicting the density of the material thereof via equation (15).

The method may also include a step to determine the ratio of work to specific surface area via equation (16) and may include determining WWW based on specific surface area via equation (17). The method may further include estimating dynamic cohesion via any one of equations (18)-(21) and accounting for dynamic cohesion, as estimated in equations (18)-(21) in any of equations (12)-(14). The method may also include a step to determine WWW while accounting for water saturation via equation (22) and/or to determine WWW while accounting for a viscosity functionality of the binder and solution via equation (23).

It is contemplated that one or more of the method steps described above may be selectively combined into a single step and/or selectively omitted. For example, the method may be configured to calculate equations (14) and (15) directly as a function of receiving one or more inputs indicative of the variables of equations (14) and (15). Such inputs may be determined via sensors measuring physical parameters, may be estimated based on historical data, and/or may be determined via one or more sub-methods via a respective one of equations set forth above. It is also contemplated that one or more of the method steps described above may include mathematically approximating, e.g., numerically integrating and/or summing, one or more of equations (2)-(25) according to any method known in the art as an alternative to, or in addition to, mathematically solving, e.g., integrating, one or more of equations (2)-(25).

### Process Apparatus

Process control apparatus may be configured to include the method described embodied as a computer executable code (program) stored on a computer readable medium, for example, stored within a memory of a general purpose computer. The apparatus may also include process equipment under the control of the computer, such as Rockwell or Honeywell Digital Control Systems (DCS) or Programmable Logic Controllers of brands such as Alfa Laval/ABB/Elsag Bailey, Allen-Bradley, ALSTOM/Cegelec, Aromat/Matsushita, Array Electronics, AutomationDirect/PLC Direct/Koyo/, B&R Industrial Automation, Bachmann, Beck Electronic/Festo, Beckhoff, Berthel gmbh, Bosch, Bristol Babcock, Cegelec/ALSTOM, CNI, Control Microsystems, Crouzet Automatismes, Control Technology Corporation, Cutler Hammer/IDT, Delta, Divelbiss, Eberle/GE-Fanuc, Yokogawa, or programmed into a personal computer able to interface with the process. As an example, the computer executable code may be configured to perform one or more of equations (1)-(25) described above and/or perform one or more of the method steps described above with respect to determining dynamic cohesion and/or predicting the endpoint of a granulation process. In particular, the method described above may be embodied in a apparatus that may include a computer, a program, and/or one or more databases as shown in FIG. 1. The apparatus may be configured to accept inputs from a user via the computer. The apparatus may be further configured to communicate and/or display data or graphics to a user via the computer. It is contemplated that the apparatus may include additional components such as, for example, a communications interface (not shown), a memory (not shown), and/or other components known in the art. It is also contemplated that the apparatus may include one or more sensors, such as, for example, torque, temperature, velocity, acceleration, mass flow, volume flow, and/or any other type of sensor known in the art. As such, the computer may be further configured to receive inputs from the one or more sensors.

It is further contemplated that the apparatus may include a rheometer and/or a granulator wherein the computer is configured to affect control of one or more components of either or both of the rheometer and/or the granulator. A rheometer and a granulator are well known in the art and as such are not further described. It is contemplated that a granulator may include a batch or continuous granulator and may include apparatus for containing the material, e.g. a bowl, apparatus to agitate the material, e.g., a mixer, impeller blade, and/or a chopper, apparatus to store and add water, e.g., a tank, reservoir, nozzle, pump, and/or water supply apparatus, and/or other equipment known in the art. It is further contemplated that the computer may, alternatively, be a controller embodied as one or more microprocessors configured to execute computer executable code and configured to control one or more components associated with the granulation process.

The computer may include a general purpose computer configured to operate executable computer code. The computer may include one or more input devices, e.g., a keyboard (not shown) or a mouse (not shown), to introduce inputs from a user into the apparatus and may include one or more output devices, e.g., a monitor, to deliver outputs from the apparatus to a user. Specifically, a user may deliver one or more inputs, e.g., data, into the apparatus via the computer to supply data to the one or more databases and/or execute the program. The computer may also include one or more data manipulation devices, e.g., data storage or software programs, to transfer and/or alter user inputs. The computer may also include one or more communication devices, e.g., a modem or a network link, to communicate inputs and/or outputs with the program. It is contemplated that the computer may further include additional and/or different components, such as, for example, a memory, a communications hub, a data storage, a printer, an audio-video device, removable data storage devices (not shown), and/or other components known in the art. It is also contemplated that the computer may communicate with the program via, for example, a local area network (“LAN”), a hardwired connection, and/or the Internet. It is further contemplated that the apparatus may include any number of computers and that each computer associated with the apparatus may be accessible by any number of users for inputting data into the apparatus, communicating data with the program, and/or receiving outputs from the apparatus.

The program may include a computer executable code routine stored in a computer memory and configured to perform one or more sub-routines and/or algorithms. Specifically, the program may be configured to perform one or more steps of the method described above. The program may receive inputs, e.g., data, from the computer and perform one or more algorithms to manipulate the received data. The program may also deliver one or more outputs, e.g., algorithmic results, and/or communicate, e.g., via an electronic communication, the outputs to a user via the computer. The program may also access the one or more databases to locate and manipulate data stored therein to arrange and/or display stored data to a user via the computer, e.g., via an interactive object oriented computer screen display and/or a graphical user interface. It is contemplated that the program may be stored within the memory (not shown) of the computer and/or stored on a remote server (not shown) accessible by the computer. It is also contemplated that the program may include additional sub-routines and/or algorithms to perform various other operations with respect to mathematically representing data, generating or importing additional data into the program, and/or performing other computer executable operations. It is further contemplated that the program may include any type of computer executable code, e.g., C++, and/or may be configured to operate on any type of computer software.

The one or more databases may be configured to store and arrange data and to interact with the program. Specifically, the one or more databases may be configured to store a plurality of data, e.g., data indicative of the output of one or more sensors, e.g., torque sensors, temperature sensors, speed or acceleration sensors, mass or volume flow sensors, and/or any other type of sensor know in the art. The one or more databases may store and arrange any quantity of data arranged in any suitable or desired format. The program may be configured to access the one or more databases to identify particular data therein and display such data to a user. It is contemplated that the one or more databases may include any suitable type of the one or more databases such as, for example, a spreadsheet, a two dimensional table, or a three dimensional table, and may arrange and/or store data in any manner known in the art, such as, for example, within a hierarchy or taxonomy, in groupings according to [other variables controlled by the computer, e.g., water purification, humidity, temperature, etc.]

### Symbol Nomenclature

Mass_{Powder} dry powder batch size (grams)
Powder_{Impeller} impeller load at each second (Watts)
P₀ Impeller power when bowl is empty (Watts)
WWW water weighted work (joules/gram)
X_{H2O} mass of water per dry powder mass (gram/gram)
η, η_{powder} dynamic cohesion (N*m/gram) or (Joules/gram)
μ viscosity (kg/m*s) or (poise)
ρ density (g/m̂3)

### Example #1

As an example only, the above method is further described herein with reference to a given API referred to hereinafter as “Drug Product-1” micronized to achieve a particle size specification to a D90 of 5 to 7 microns and increasing in tap density from nominal value of approximately 0.3 g/cc to 0.7 g/cc during granulation.

The following example considers three (3) lots of Drug Product-1, each from the same source but subjected to differing micronization milling energies of 60 kJ/kg, 180 kJ/kg, and 280 kJ/kg and having dynamic cohesions of 6.8 Nm/30 g, 11.0 Nm/30 g, and 12.2 Nm/g, respectively. The granulation of the three lots considers a 5-minute water addition at 25% wt/wt water. The following table, Table 1, shows four (4) samples taken from each of the three lots at wet massing times of 0.4 minutes, 1.3 minutes, 2.5 minutes, and 3.8 minutes establishing twelve (12) samples from each granulation. Table 1 also shows the percentage dissolution of a film coated tabled after 45 minutes, wherein greater than 90% dissolution is near optimal dissolution, and greater than 95% dissolution is considered optimal.

TABLE 1
Lots of Drug Product - 1

| | | Granulation Wet Massing Time and Percent of | | | |
|---|---|---|---|---|---|
| Microniza- | Powder | Coated Tablet Dissolution after 45 Minutes | | | |
| tion Work | Cohesion | 0.4 min | 1.3 min | 2.5 min | 3.8 min |
| 60 | 6.8 | 89 | 91 | 87 | 52 |
| 180 | 11.0 | 86 | 93 | 92 | 85 |
| 280 | 12.2 | 87 | 86 | 92 | 91 |

FIG. 2 shows a comparison between impeller load and elapsed granulation time for the three lots, i.e., the 60 kJ/kg, 180 kJ/kg, and the 280 kJ/kg lots. FIG. 3 shows a comparison between the final 10-second average impeller load and dissolution percentage and density of the 12 samples. FIG. 4 shows a comparison between ending impeller load and milled granule tap density.

No reasonably discernable pattern or correlation between impeller load and the degree of granulation is observed in FIG. 2. Similarly, no reasonable relationship can be drawn between final impeller load and dissolution percentage or density as seen in FIG. 3. Additionally, no reasonably meaningful correlation between ending impeller load and tap density is shown in FIG. 4. That is, impeller load may not be a suitable parameter for controlling granulation processes or in predicting dissolution of granulated materials. As such, although impeller load may be conventionally used to control a granulation process, from FIG. 2, impeller load may simply be a measure of how fast the granulation process is occurring and the difficulty in predicting granulation based on impeller load may be due to other factors affecting impeller load in addition to the output granule properties.

FIG. 5 shows a comparison between work, as derived from equation (1) and tap density, and may show an improved correlation with tap density with respect to impeller load as shown in FIG. 4. Thus, equation (1) may be more useful for predicting tap density of granulated powder than impeller load. FIG. 6 shows a comparison between work, as derived from equation (1), and dissolution percentage and density of the 12 samples. Similar to FIG. 3, however, no reasonable relationship can be drawn between work and dissolution percentage or density. Thus, although equation (1) may be useful as control model for granulation endpoint to predict and/or control tap density, it may be not be suitable for predicting dissolution or controlling a granulation process. It is contemplated that equation (1) may be relatively less accurate for predicting tap density if the water addition amount, addition rate, and feed material particle size or rheology vary substantially.

FIG. 7 shows a comparison between work/cohesion, as derived from equation (11) and tap density, and may show an improved correlation with tap density as compared to work shown in FIG. 5. Thus, equation (11) may be more accurate for predicting tap density of granulated powder than work and impeller load. FIG. 8 shows a comparison between work/cohesion, as derived from equation (11), and dissolution percentage and density of the 12 samples. As shown in FIG. 8, an improved relation to density and dissolution may be observed. For example, characteristic bell curves for dissolution of under-granulated and over-granulated material can be seen. Thus, equation (11) may be useful to control a granulation process, e.g., by controlling process time, water additions, and/or other granulation process parameters, to reduce or prevent under-granulation or over-granulation. It is contemplated that equation (11) may be less accurate for predicting tap density and under/over-granulation if the water addition amount, addition rate, and feed material particle size or rheology vary substantially.

FIG. 9 shows a comparison between WWW/cohesion, as derived from equation (12) and tap density, and may show yet a further improved correlation with tap density as compared to work/cohesion as shown in FIG. 5. Thus, equation (14), alone or in conjunction with any of equations (6)-(8), may be more accurate for predicting tap density of granulated powder than work/cohesion, work, and impeller load. FIG. 10 shows a comparison between WWW/cohesion, as derived from equation (14) in conjunction with equation (8), and dissolution percentage and density of the 12 samples. As shown in FIG. 10, a yet further improved relation to density and dissolution may be observed. For example, the characteristic bell curves of under-granulated and over-granulated material may be more discernable as compared to those shown in FIG. 8. Thus, equation (14), alone or in conjunction with any of equations (6)-(8), may allow for a more accurate control of a granulation process and may reduce or prevent under-granulation or over-granulation of material. It is contemplated that equation (14), alone or in conjunction with any of equations (6)-(8), may be relatively more accurate for predicting tap density and under/over-granulation when the water addition amount, addition rate vary substantially, such as may occur as a normal variation between different granulation processes.

Thus, as may be observed from FIGS. 2-10, although impeller load is often used as a method to control granulation, it may not provide useful correlation to tap density, dissolution, or density. Additionally, work, i.e., equation (1), may provide an improved correlation to tap density, but may not provide a useful correlation to dissolution or density and may become inaccurate as a function of changes to water amount and/or addition rate. Work/cohesion, i.e., equation (14), may provide an improved correlation to tap density as well as dissolution and density, however, it may be susceptible to inaccuracies as water changes. Furthermore, WWW/cohesion, i.e., equation (14), may provide an improved correlation to tap density, dissolution, and density as compared with either impeller load, work, or work/cohesion and may be less susceptible to inaccuracies as changes to water amount and/or addition rate as compared to work/cohesion.

### Example #2

The WWW model assumes that granulation starts the moment water is applied to the granulation mixture, and simply proceeds faster as more water is added, thus power input needs to be weighted more heavily when more water is present. Instead, what may be observed is that water can be added up to a certain point, with no detectable change to the system. The amount of water needed to start coalescence is related to the critical Stokes number, and described in Litster et. al. as function of particle diameter, and velocity. Litster, L. X. Liu; Iveson, S. M.; Ennis, B. J.; “Coalescence of Deformable Granules in Wet Granulation Processes” AlChE Journal, 2000, Vol. 46, No. 3.

Therefore, there is a certain saturation point where particle surfaces are covered with enough water (Xₛₐₜ) that needs to be achieved prior to granulation starting. Adding water beyond this critical point is what causes the granulation process to proceed.

“Saturated Weighted Work” (SaWW), as described in Equation (23) is the granulation process using the idea of water in excess of a certain critical amount.

SaWW=∫₀^{t}(Power_{Impeller}−P₀)·X_{S}dt Equation (23)

Where Xₛ is the amount of water above the saturation point, which is defined as follows:

X_{S}=(X_{H2O}−X_{SAT}) Equation (24)

Xsat is defined as the amount of water needed before the impeller load begins to increase as more water is added.

Xsat can be found using a variety of mathematical techniques. An example technique is to find the point where the impeller load mean value for 10 seconds is 3-sigma higher than the previous 30 seconds worth of data. A second way which appears slightly more accurate is to find the point of minima of the equation

(Power_{Impeller}−P₀)/X_{H2O} Equation (26)

after a 15-second backwards data averaging is used to smooth the impeller load data. The two methodologies agree with an R² of 90% for the DOE data described in this example where Xsat lies in range from 20% to 22%.

Variation in Xsat is very clearly observable in the data by plotting impeller load versus water fraction added during the water addition phase. An example of a batch at 20% Xsat versus 22% Xsat is presented in FIG. 11. Different trajectories are observed dependant upon point where impeller load starts to increase.

To examine the effects of variation in water addition amount in high shear granulation, a 10-batch granulation DOE was conducted at 300-L scale. Water was varied at 3 levels of 28%, 30%, and 32% with three differing work endpoint for each water level, and a replicate batch at the centerpoint. The resulting 10 granulations were then split into five sublots to test five levels of compressed tablet thickness. The resulting DOE data table calculated to allow comparison between Work and SaWW model form is presented in FIG. 12.

Variation in this saturation point (Xsat) appears to be the main reason different granulations run at slightly different speed. Amount of water in excess of Xsat, referred to as “Xs”, appears to be a significant term. A dissolution model can be built on Granulation Time, Xs, and Tablet Thickness, as summarized in FIG. 13.

The above model suggests that if Xsat is determined during water addition, and amount of water added is known, then the granulation process could be run off Time as function of Xsat with improved precision compared to a model which uses time and water content as stopping criteria

Use of Xsat in the differential equation similarly improves predictive qualities of the endpoint model. Application of the SaWW model to the data set finds improvement in R² of prediction for Dissolution when the same response surface model terms are used for both the DOE data set, and all the 300-L process data at 5-minute water addition time in granulation. The model summary in comparison to Work is presented in FIG. 15 and resulting response surfaces for DOE data comparing Work versus SaWW as measure of endpoint is presented in FIG. 14. FIG. 14 demonstrates that the Work model is significantly dependant upon water amount added, whereas the SaWW model substantially reduces the dissolution response to water amount.

Comparison of model 3 to model 4 in FIG. 15 shows the response surface of dissolution versus the SaWW model is nearly independent of water amount, such that the statistical model from DOE data can be simplified from 10 terms to 6 terms, neglecting all water affects without significant loss of R² (91% versus 93%) for prediction of dissolution. The Work endpoint model (model 1) in FIG. 15 is significantly dependant upon consistent water amount added to granulation, and consistent raw material response to the water addition. Model 2 in FIG. 15 shows the Work model is improved if considered versus Xs instead of absolute water amount. The SaWW model can allow the process to accommodate variation in water addition, and variation in the how the input raw material responds to the water addition.

The SaWW differential equation reduces to the Work differential equation when the water addition rate, amount, and saturation point of raw material is consistent. It is therefore useful to examine what the variability has been in the saturation point of the raw material when deciding when to utilize the SaWW model versus the Work or WWW models.

Another aspect to be aware of is that Xsat changes significantly with scale, and correlated strongly with mixing Froude number for each scale. This explains why more water is generally needed if granulation processes are scaled up at constant tip speed. To provide an example picture of how impeller load responds to water content at the varying scales, the impeller load at each moment in time was divided by the average impeller load observed from 0% to 15% water content added. This creates a scaled impeller load (P*), with a scaled value of approximately one when no response has yet been noted. P* allows development of a plot of example impeller load response between scales and is shown in FIG. 16.

FIG. 17 provides summary of the average Xsat value found at each scale for granulations with 5-minute water addition time, and API micronized within specification range. This table provides a potential explanation why 23% to 26% water was effective at 25-L and 65-L scale, but had to be increased to 28% water at 150-L scale, and 30% water at 300-L scale. Effectively the amount of water in excess of saturation point (Xs) was held approximately consistent at 9% during scaleup whereas absolute amount of water was not.

When the average Xsat determined for each scale is plotted versus the Froude number at that scale, a linear line with 99% R² is observed (FIG. 18). Froude number can be thought of as a measure of the number of the gravitational forces (g-forces) of centrifugal force at the granulator blade tip. The centrifugal force is necessary for accelerating the powder bed into toroidal (roping) flow, which is the predominant flow pattern at later stages in granulation. The centrifugal force also creates a compressive force pressing the powder bed toward the outside walls. This relationship is suggestive that at higher centrifugal force less water needs to be present to start the process of granule growth and densification. Froude number is a function of impeller rpm² and radius of the impeller.

The method and apparatus described above may be useful for predicting granulation affects and granulated material properties for unknown materials, may account for changes in material between batches of the same type of material, and may be useful regardless of crystallization. Additionally, the above method and apparatus may provide a more precise granulation control and may be configured to predictably granulate multiple batches of material each having granulated material properties within a predetermined and/or desired range. Furthermore, although the above described methods and apparatus appear applicable to Drug Product-1, it is contemplated that the methods and apparatus are applicable for granulations of other materials to help characterize the granulation process.

All publications, including but not limited to patents and patent applications, cited in this specification are herein incorporated by reference as if each individual publication were specifically and individually indicated to be incorporated by reference herein as though fully set forth.

The above description fully discloses the invention including preferred embodiments thereof. Modifications and improvements of the embodiments specifically disclosed herein are within the scope of the following claims. Without further elaboration, it is believed that one skilled in the art can, using the preceding description, utilize the present invention to its fullest extent. Therefore, the Examples herein are to be construed as merely illustrative and not a limitation of the scope of the present invention in any way. The embodiments of the invention in which an exclusive property or privilege is claimed are defined as follows.

1. A method for predicting when to stop granulating a material during a granulation process, comprising:
a) estimating the work imparted to the material by the impeller;
b) estimating the water fraction associated with the granulation process; and
c) predicting at least one of resulting granule density, resulting granule size, resulting granule porosity, resulting granule dissolution, bulk powder tap density, bulk powder density, estimated tablet dissolution, estimated tablet porosity, and/or estimated tablet porosity as a function of the estimated work and estimated water fraction.

2. An apparatus comprising a computer executable code stored on a computer readable medium for executing the method of claim 1.

3. A method for controlling a granulation process, comprising:
a) estimating a first parameter of the granulation process indicative of an amount of water added during the granulation process; and
b) estimating a second parameter of the granulation process indicative of the power associated with an impeller of a granulator;
c) estimating a first value as a function of the first and second parameters per time increment; and
d) controlling the granulation process to stop when the first value is greater than a predetermined value.

4. The method of claim 3, wherein estimating the first value by summing or numerically integrating the first and second parameters for a plurality of time increments.

5. The method of claim 4, wherein controlling the granulation process to stop establishes a granulated material having at least one of resulting granule density, resulting granule size, resulting granule porosity, resulting granule dissolution, bulk powder tap density, bulk powder density, estimated tablet dissolution, estimated tablet porosity, and/or estimated tablet porosity within a predetermined range of acceptable values.

6. The method of claim 3, wherein estimating the first parameter includes estimating at least one of (i) a water addition rate as a function of either the change in water mass of a supply tank or a rate of water being pumped into a granulator, or (ii) a water spray pattern as a function of a pressure drop associated with a spray nozzle or by fixing the characteristics of a spray nozzle.

7. The method of claim 3, further including:
a) estimating a second value indicative of dynamic cohesion of the material;
b) estimating a third value as a function of the first and second values; and
c) predicting at least of resulting granule density, resulting granule size, resulting granule porosity, resulting granule dissolution, bulk powder tap density, bulk powder density, estimated tablet dissolution, estimated tablet porosity, and/or estimated tablet porosity as a function of the third value.

8. The method of claim 7, wherein estimating the first parameter includes estimating the affects of stopping and restarting the granulator during the process.

9. An apparatus comprising a computer executable code stored on a computer readable medium for executing the method of claim 8.

10. A method for controlling a granulation process, comprising:
a) estimating a first amount of work indicative of the work that needs to be transferred to a material via the process to achieve a determined endpoint a determined densification of the material based on at least one of a water addition rate associated with the granulation process, or a water addition amount associated with the granulation process; and
b) estimating a second amount of work indicative of the work that an impeller transfers to the material via the process; and
b) estimating when to cease operating the granulation process when the as a function of the first and second amounts of work are approximately equivalent to each other.
such that the estimated amount of work is transferred to the material.

11. The method of claim 10, further including scaling the estimated second amount of work as a function of at least one of dynamic cohesion, particle size or surface area of the material being granulated.

12. The method of claim 10, further including estimating the first amount of work as a function of a water addition rate associated with the granulation process.

13. The method of claim 10, further including estimating the first amount of work as a function of the water addition amount associated with the granulation process.

14. The method of claim 10, wherein estimating when to cease operating the granulation process includes predicting a time for operating the granulation process.

15. The method of claim 10, wherein estimating when to cease operating the granulation process includes predicting a time for operating the granulation process and scaling the predicted time as a function of dynamic cohesion.

16. An apparatus comprising a computer executable code stored on a computer readable medium for executing the method of claim 10.

17. An apparatus for controlling a granulator, comprising:
a controller operatively connectable to the granulator, the controller including a computer readable memory having stored therein a computer executable code for:
a) estimating the work imparted to a material by the impeller;
b) estimating the water fraction associated with the granulation process; and
c) predicting at least one of resulting granule density, resulting granule size, resulting granule porosity, resulting granule dissolution, bulk powder tap density, bulk powder density, estimated tablet dissolution, estimated tablet porosity, and/or estimated tablet porosity as a function of the estimated work imparted to the material and the estimated water fraction.

18. The apparatus of claim 17, further including a granulator selected from the group of a high shear granulator, an extruder, a continuous twin screw granulator, a single screw granulator, or a plow shear granulator.

19. The apparatus of 17, wherein the controller is configured to affect control of the granulator.

20. A system for controlling a granulation process, comprising:
a computer;
a user interface; and
a computer executable program stored in a computer memory device being capable of:
comparing data indicative of an amount of power input to the granulation process and data indicative of an amount of water added to the granulation process to predict an amount of work input to a material during the granulation process, and
determining an operating duration that the granulation process is to be operated to as a function of the predicted amount of work.

21. The system of claim 20, further including a granulator, wherein the computer is configured to control the granulator to cease operating after being operated for the determined operating duration.

22. The system of claim 21, wherein the computer executable program is further capable of determining the operating duration based on the formula
$${WWW}_{1} = {\int }_{0}^{Time} \frac{( {Power}_{Impeller} ) \cdot {X}_{H 2 O}}{{Mass}_{Powder}} d t$$
wherein Time is indicative of the operating duration, Power_{Impeller} is indicative of the amount power input to the granulation process, X_{H20} is indicative of the amount of water added to the granulation process, Mass_{powder} is indicative of the mass of material being granulated, and WWW is indicative of the predicted amount of work input to the material during the granulation process.

23. The system of claim 22, wherein the computer executable program is further capable of determining the amount of power input to the granulation process based on the formula Power_{Impeller}=Torque×RPM, wherein Torque is indicative of the torque of an impeller associated with the granulation process and RPM is indicative of the rotational speed of the impeller.

24. The system of claim 22 wherein the computer executable program is further capable of determining the amount of power input to the granulation process based on the formula Power_{Impeller}=Pₘₒₜₒᵣ−P₀, wherein Pₘₒₜₒᵣ is indicative of the power of a motor configured to rotate an impeller associated with the granulation process when the impeller is engaged with a material and P₀ is indicative of the power of the motor configured to rotate the impeller when the impeller is not engaged with a material.

25. The system of claim 22, wherein the computer executable program is further capable of determining the amount of power input to the granulation process based on the formula Power_{Impeller}=Torque×RPM−Torque₀×RPM, wherein Torque is indicative of the torque configured to rotate an impeller associated with the granulation process when the impeller is engaged with a material, RPM is indicative of the rotational speed of the impeller, and Torque₀ is indicative of the torque of the impeller configured to rotate the impeller when the impeller is not engaged with a material.

26. The system of claim 20, wherein the computer executable program is further capable of determining the operating duration based on the formula
$${WWW}_{2} = {\int }_{0}^{Time} \frac{ɛ \cdot ( {Power}_{Impeller} ) \cdot {X}_{H 2 O}}{{Mass}_{Powder}} d t$$
wherein Time is indicative of the operating duration, Powen_{Impeller} is indicative of the amount power input to the granulation process, X_{H20} is indicative of the amount of water added to the granulation process, Mass_{powder} is indicative of the mass of material being granulated, ε is indicative of the efficiency of an impeller associated with the granulation process, and WWW₂ is indicative of the predicted amount of work input to the material during the granulation process.

27. The system of claim 20, wherein the computer executable program is further capable of determining the operating duration based on the formula
$${WWW}_{3} = {\int }_{0}^{Time} \frac{ɛ \cdot ( {Power}_{Impeller} ) \cdot {X}_{H 2 O}}{{Mass}_{Powder} \cdot η} d t$$
wherein Time is indicative of the operating duration, Power_{Impeller} is indicative of the amount power input to the granulation process, X_{H20} is indicative of the amount of water added to the granulation process, Mass_{powder} is indicative of the mass of material being granulated, ε is indicative of the efficiency of an impeller associated with the granulation process, WWW₃ is indicative of the predicted amount of work input to the material during the granulation process, and η is indicative of the cohesive properties of the material being granulated.

28. The system of claim 20, wherein the computer executable program is further capable of determining the operating duration based on the formula
SaWW=∫₀^{t}(Power_{Impeller}−P₀)·X_{S}dt
wherein Time is indicative of the operating duration, Power_{Impeller} is indicative of the amount power input to the granulation process, P0 is indicative of the baseline impeller load when no material is in the granulator, Xs is indicative of the amount of water above a critical amount defined as Xs=(X_{H2O}−X_{critical}), SaWW is indicative of the predicted amount of work input to the material during the granulation process if water amounts or material response to the water is changing.

29. The system of claim 28 where Xcritical is defined as water fraction added before the granulator main impeller power starts increasing.

30. The system of claim 28 where Xcritical is defined as amount of water needed to saturate the formulation as determined by Gravimetic Vapor Sorption.

31. The system of claim 28 where Xcritical is predicted as function of input material specific surface area, dynamic cohesion, or Particle Size Distribution.

32. The system of claim 28 where Xcritical is defined as function of impeller Froude Number.

33. The system of claim 28 where Xcritical is defined as a multivariable relationship including at least one of following parameters, material particle size distribution, specific surface area, dynamic cohesion value, impeller Froude Number.

34. The system of claim 28 where the integration is divided by mass of the powder bed to predict values on a per mass basis.

35. The system of claim 28 where the Work value needed to stop the granulation is calculated as function of at least one of SaWW, Xs or Xsat.

36. The system of claim 28 where the Time needed to stop is calculated as function of at least one of SaWW, Xs or Xsat.

37. A method, comprising:
a) loading an amount of powder material into a bowl of a rheometer;
b) controlling an impeller blade of the rheometer to pass through at least a portion of the loaded material;
c) determining an amount of torque associated with the impeller blade at a given depth of the loaded material; and
d) determining dynamic cohesion as a function of the amount of torque and the amount of powder material.

38. The method of claim 37 further including conditioning the loaded material to establish a substantially standard density.

39. The method of claim or 38 wherein conditioning the loaded material includes passing the impeller blade through the loaded material in a helical pattern.

40. The method of claim 39 further including determining dynamic cohesion by dividing the determined amount of torque by the mass of the loaded material.

41. A method of controlling a granulation process as a function of dynamic cohesion.

42. A computer executable code stored in a computer readable memory configured to perform the method of claim 41.

43.-46. (canceled)

47. A method for predicting the endpoint of a granulation process, comprising:
a) estimating the power imparted to the material by the impeller;
b) estimating the time power has been applied to the material;
c) estimating the water fraction associated with the granulation process; and
d) predicting the endpoint of the granulation process based on at least one of resulting granule density, resulting granule size, resulting granule porosity, resulting granule dissolution, bulk powder tap density, bulk powder density, estimated tablet dissolution, estimated tablet porosity, and/or estimated tablet porosity determined as a function of the estimated power imparted to the material and the estimated water fraction.

48. An apparatus comprising a computer executable code stored on a computer readable medium for executing the method of claim 47.
